(19) United States
(12) Patent Application Publication
(10) Pub. No.: US 2026/0367930 A1
(43) Pub. Date: Nov. 19, 2026

(54) DISCOVERING COMPUTER PROGRAMS USING LANGUAGE MODEL NEURAL NETWORKS

(71) Applicant: GDM Holding LLC, Mountain View, CA (US)

(72) Inventors: Alexander Novikov, London (GB); Thuy Ngan Vu, London (GB); Emilien Dupont, Mountain View, CA (US); Marvin Eisenberger, Mountain View, CA (US); Po-Sen Huang, London (GB); Zsolt Adam Wagner, London (GB); Sergey Shirobokov, London (GB); Borislav Kozlovskii, London (GB); Francisco Jesus Rodriguez Ruiz, London (GB); Abbas Mehrabian, Montreal (CA); Pawan Kumar Mudigonda, London (GB); Abigail Elizabeth See, London (GB); Swarat Chaudhuri, London (GB); Matej Balog, London (GB)

(21) Appl. No.: 19/677,893

(22) Filed: May 14, 2026

Related U.S. Application Data
(60) Provisional application No. 63/805,911, filed on May 14, 2025.
(60) Provisional application No. 63/978,905, filed on Feb. 9, 2026.

(51) Int. Cl. G06F 9/445; G06F 16/23; G06N 3/0475

(52) U.S. Cl. CPC G06F 9/44505; G06F 16/23; G06N 3/0475

(57) ABSTRACT

Systems and methods for searching through a space of candidate computer programs for performing a task to determine a final computer program that includes information of how to perform the task (i.e., steps and processes to accomplish a task).

### CROSS REFERENCE TO RELATED APPLICATIONS

This application claims priority to U.S. Provisional Application No. 63/805,911 filed on May 14, 2025, and U.S. Provisional Application No. 63/978,905 filed on Feb. 9, 2026. The disclosure of the prior application is considered part of and is incorporated by reference in the disclosure of this application.

### BACKGROUND

This specification relates to computer program generation using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a computer system implemented as computer programs on one or more computers in one or more locations that determines a computer program for performing a task by searching through a space of candidate computer programs.

The subject matter described in this specification can be implemented in particular embodiments so as to realize one or more of the following advantages.

The ability to determine how to generally perform a task (i.e., steps and processes to accomplish a task) is invaluable to solving problems across any domain, e.g., scientific research, business operations, database operations, and so on. For many tasks, evaluating the performance of outputs for a task is easy, but determining how to perform the task is often difficult for a number of reasons. For example, determining how to perform a task includes exploring a huge space of possible solutions, the majority of which may be incorrect or sub-optimal. Exploring a huge solution space is computationally challenging and is often impossible or impractical to evaluate exhaustively.

For example, the process of generating a solution to how to perform a task often involves brute-force evaluation of many possible ways to perform the task. But the number of possible ways to perform the task is often impossible to exhaustively evaluate (or too large to practically evaluate).

As another example, large language models can be applied, but conventional language model reasoning often fails (e.g., produces incorrect or hallucinated outputs) when applied to complex, multi-component systems.

As another example, some solutions often do not explicitly consider multiple performance dimensions/metrics. That is, the optimal way to perform a task can include multiple aspects (i.e., multiple performance dimensions) instead of just a single explicit desired outcome, and common solutions to how to perform a task often do not consider these multiple performance dimensions, focusing instead on a single desired outcome.

Given these challenges, a method to automatically identify how to perform tasks and verify their correctness by efficiently exploring a space of possible solutions would be invaluable for discovering and enhancing solutions for how to perform tasks.

This specification describes techniques that can address the aforementioned challenges by searching through a space of candidate computer programs for performing a task to determine a final computer program that includes information of how to perform the task (i.e., steps and processes to accomplish a task). That is, the techniques described in this specification determine a final computer program starting with an initial computer program using an evolutionary search procedure that uses diverse pre-trained language models to generate improved new candidate computer programs and uses multiple evaluation functions to verify the quality of the new candidate computer programs across a variety of performance dimensions. As a consequence, the final computer program can be determined in an automatic fashion and performs the task (often using novel steps and processes) more effectively than previous computer programs for the task. This specification also describes techniques for performing tasks, involving determining a computer program using an evolutionary procedure and executing the computer program to perform the task.

The use of a diverse set of pre-trained language models enables an exploration of candidate computer programs, balancing exploring known, successful solutions and creative solutions. At the same time, the use of multiple evaluation functions (and their respective generated scores) to verify the quality of the new candidate computer programs ensures that selected candidate computer programs can perform well for multiple performance dimensions.

In particular, the techniques described in this specification achieve superior computational speed by utilizing partial code generation rather than full-file rewrites as in standard code generation techniques. The techniques described herein can instruct the underlying language models to output only specific portions of code required for a mutation, significantly reducing the number of tokens generated per iteration. This approach minimizes the processing overhead associated with the inference cycles of the language model, allowing for a higher throughput of proposed solutions within a fixed compute budget. Even so, as opposed to methods that are limited to evolving a small portion of source code, the techniques described in this specification are capable of evolving hundreds of lines of code across a multitude of components.

Additionally, as opposed to methods that are limited to evolving a single function in a single programming language, the techniques described in this specification allow evolution over entire codebases written in a wide range of programming languages, enabling simultaneous modification of intricate, interdependent components of a system. As such the techniques described herein can tackle onerous tasks where changing one component necessitates changes in another, which is often a challenge. Additionally, by supporting a wide range of programming languages, the techniques described in this specification can evolve both hardware and software at different levels of the computing stack, optimizing low-level hardware, high performance kernels and heuristics.

Furthermore, the introduction of a multi-stage evaluation cascade during evaluation of new candidate computer programs allows poorly performing programs to be pruned quickly. This ensures that intensive processor time and high-latency evaluations are reserved only for the most promising candidates, dramatically accelerating the discovery timeline from months of to mere days.

As another example, the techniques described herein provide the ability to perform multi-objective optimization as opposed to optimizing a single objective function. More specifically, the techniques can apply a set of multiple evaluation functions to each evolved code program, where each evaluation function simultaneously measures different of complementary performance dimensions (e.g., execution latency, peak memory consumption, numerical accuracy, etc.) Many high-value tasks are not single-metric and high quality solutions must optimize one or more optimization objects. As opposed to methods that only enable optimization of a single metric, the techniques described herein enable optimization between one or more performance dimensions, enabling a balanced solution that optimizes power and memory space while preserving core functionality and latency requirements. Additionally, optimizing across multiple objectives encourages the development of diverse solutions, increasing the likelihood of finding novel algorithms that generalize well to unseen or large-scale datasets.

Similarly, as opposed to methods that leverage language models for code generation, the techniques described in this specification use state of the art language models and rich forms of natural-language context and feedback. Additionally, the techniques described herein can also utilize a mixture of smaller, low-latency language models and large, more robust language models for candidate computer program generation. That is, while the techniques described herein leverage the advantages of robust state of the art language models, the techniques also balance these more-compute heavy, robust models with smaller, more efficient models to enhance generation speed and lighten the compute and memory load. From a processor usage perspective, the ability to utilize smaller, low-latency language models for high-volume candidate generation, while reserving larger models for complex reasoning, ensures an optimal balance between computational speed and solution quality.

As another example, as opposed to language model code generation that leverages millions of samples, the techniques described herein can utilize only thousands of samples given the rich context given to the multitude of language models. More specifically, previous language model code generation techniques generate millions of individual code proposals to find a high-quality final solution, consuming massive amounts of processing power and latency. That is, the techniques described herein can provide rich context and feedback in the prompts presented to the language models, enabling the language models to make more informed decisions, while also leveraging partial code generation and an ensemble of language models. This contrasts the language model code generation techniques that provide minimal context (only previous solutions), can only complete full code generation of minimal lines of code, and use a small number of less capable language models.

Additionally, the techniques described herein can optimize memory and storage usage through a hybrid database architecture that separates global "elites" candidate computer programs from isolated "islands" candidate computer programs. This hierarchical structure prevents the techniques described herein from being saturated by redundant solutions, as it can employ inverse frequency weighting to ensure a uniform coverage of the Pareto frontier.

In a practical use case like electric grid optimization, the techniques described herein can demonstrate memory efficiency by simplifying complex network architectures—for instance, replacing multiple unique multilayer perceptrons (MLPs) with a single, shared MLP for all message-passing steps. This reduction in model parameters not only lowers the memory footprint of the resulting algorithms but also enhances their practical feasibility for real-world deployment where computational resources may be constrained. That is, beyond its own operational efficiency, the techniques described in this specification generate algorithms that provide significant downstream technical advantages for external systems. By discovering a rank-48 algorithm for a 4x4 matrix multiplication—the first improvement in 56 years—the techniques described herein can reduce the total number of scalar multiplications required, directly lowering the processor workload for fundamental computational tasks.

Additionally, the described techniques of this specification enable the asynchronous and parallel generation and evaluation of candidate computer programs, which improves the computational resource efficiency and the computational latency of generating and selecting a final computer program for performing a task. For example, the described techniques enable parallel and asynchronous operations for candidate computer program generation, such as generating input prompts independently of each other for each pre-trained language model and processing each of the input prompts independently of each other using the respective pre-trained language models to generate candidate computer programs. As another example, the described techniques enable the parallel and asynchronous operations for evaluating the newly generated candidate computer programs, such as applying a set of evaluation functions for a task to candidate computer programs in parallel. In addition to applying the set of evaluation functions to each candidate computer program in parallel, the described techniques also enable applying each function in the set of evaluation functions in parallel for each individual candidate computer program. As another example, the described techniques enable parallelism through the use of multiple programs database devices that maintain the program database, multiple sampler devices that each perform the operations for candidate computer program generation in parallel with each other, and multiple evaluator devices that each perform the operations for evaluating the newly generated candidate computer programs in parallel with each other. Moreover, the sampler devices and the evaluator devices can operate in parallel with each other. As such, the techniques described herein optimize the total volume of ideas proposed and evaluation for generation of a new candidate computer program. By decoupling the different stages of the discovery loop – sampling, generation, and evaluation – while performing different iterations of the discovery loop in parallel, the system can ensure that no-single high latency task stalls the entire process, and allows the techniques described herein to explore vast and complex search spaces. On the other hand, the parallel evaluation enables the techniques described herein to evaluation for hours, in parallel, on multiple accelerators to result in the highest quality final computer program.

As a consequence, the described techniques not only improve the determination of a computer program for performing a task compared to other techniques but also reduce the associated computational latency by fully leveraging available computational resources compared to conventional techniques.

The details of one or more embodiments of the subject matter will become apparent from the description, drawings, and the claims.

Other features, aspects, and advantages of the subject matter will become apparent from the description, drawings, and the claims.

### BRIEF DESCRIPTION OF THE DRAWINGS

FIG. 1 is a diagram of a system that determines a computer program for performing a task by searching through a space of candidate computer programs.

FIG. 2 is a detailed view of the system that includes inputs and a sequential logic flow for a controller loop.

FIG. 3 is a diagram of specification data that includes a skeleton computer program having fixed blocks of code and dynamic blocks of code.

FIG. 4A is a diagram illustrating a parallelized candidate generation process of the controller loop of the system.

FIG. 4B is a diagram illustrating a parallelized evaluation process of the controller loop of the system.

FIG. 5 is a more detailed view of the program database that partitions candidate computer programs into groups.

FIG. 6 is a table comparing performance metrics for matrix multiplication between a baseline solution and a solution generated by the described system.

FIG. 7 illustrates an evaluation pipeline and resulting bar chart of error results for a quantum circuit generator task.

FIG. 8 is a flowchart of a process for selecting a candidate computer program as a final computer program for performing a task.

FIG. 9 is a flowchart of a subprocess for performing a search to update a program database of the process of FIG. 8.

FIG. 10 is a flowchart of a subprocess for performing candidate generation operations using a language model neural network of the process of FIG. 9.

FIG. 11 is a flowchart of a subprocess for performing evaluation operations on new candidate computer programs of the process of FIG. 9.

Like reference numbers and designations in the various drawings indicate like elements.

### DETAILED DESCRIPTION

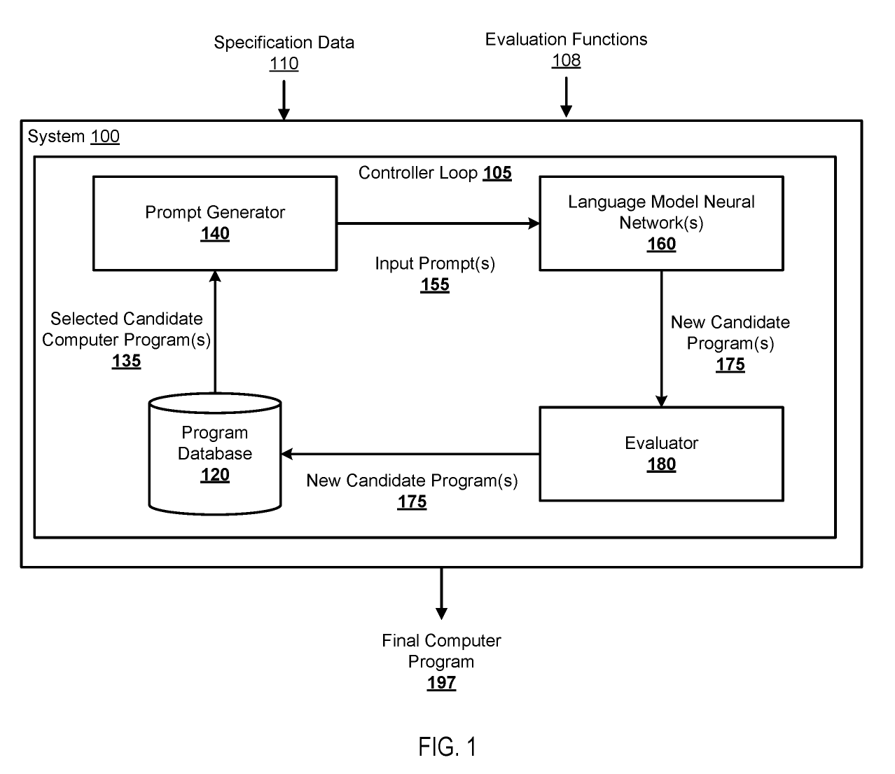

FIG. 1 shows an example system 100 that determines a computer program for performing a task by searching through a space of candidate computer programs. The system 100 is an example of a system implemented as computer programs on one or more computers in one or more locations in which the systems, components, and techniques described below are implemented.

In particular, the system 100 can receive specification data 110 including an initial computer program specifying a task and at least a set of one or more evaluation functions 108 for the task to be used by the system 100 to evaluate new candidate computer programs 175 that evolve the initial computer program.

The system 100 can determine a final computer program 197 for performing the task by searching through a space of candidate computer programs 135. The final computer program 197 is a computer program that receives as input an input for the task and that generates as output an output for the task.

To determine the final computer program 197 for performing the task, the system 100 has a distributed architecture configured to iteratively evolve computer code through a controller loop 105 that leverages a program database 120, a prompt generator 140, one or more language model neural networks 160 and an evaluator 180.

At a high level, the system 100 can receive specification data 110 including an initial computer program specifying a task to be solved and a set of one or more evaluation functions 108 that each evaluate the performance of a computer program on the task to be solved. To determine the final computer program 197 from the specification data 110 and the set of one or more evaluation functions 108, the system 100 can initialize the program database 120 of candidate computer programs (i.e., preliminary versions of computer programs written in one or more programming languages, such as C++, Python, or both, or one or more hardware description languages (HDL), such as Verilog and VHDL, that are generated based on the skeleton computer program of the specification data 110) for performing the task. The system 100 can then perform a search to update the program database 120 to evolve the code of the candidate computer programs. As part of the search, the system 100 can repeatedly perform candidate generation operations within the controller loop 105 for each of the one or more language model neural networks 160. That is, the system 100 can repeatedly evolve one or more selected candidate computer programs 135 by prompting each of the one or more language model neural networks 160 to generate new candidate computer programs 175 based on a selected candidate computer program of the one or more selected candidate computer programs 135 until a final computer program 197 can be determined.

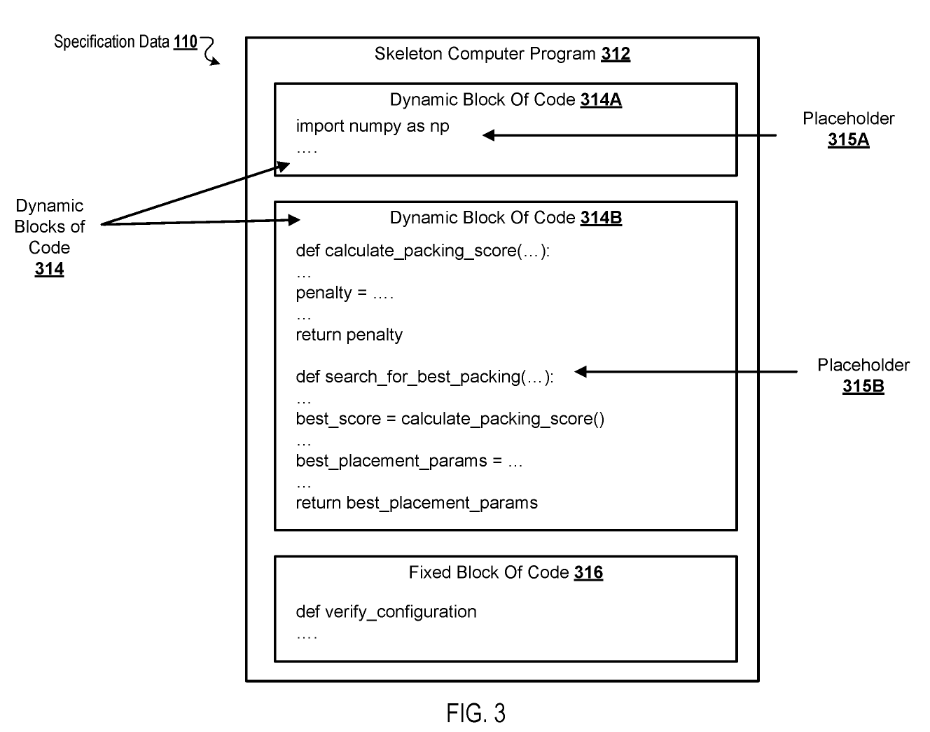

The specification data 110 can be any appropriate data configured to specify the task to be solved and including a computer program to evolve. In some cases, the specification data includes a (initial) skeleton computer program that specifies the task, where the skeleton computer program includes one or more fixed blocks of code and placeholders for one or more dynamic blocks of code. For such cases, a new candidate computer program 175 is a respective instance of the one or more fixed blocks of code and one or more dynamic blocks of code. In some cases, the placeholders each include an input API (or annotations) indicating a block-start and block-end point for the respective dynamic block of code. The specification data 110 is described in more detail below with reference to FIG. 3.

The task can be any of a variety of tasks, e.g., optimization tasks. For example, the task can be a combinatorial optimization task (e.g., optimally generate supply chain plans, optimally deliver packages, optimally generate an optimal water distribution schedule, and so on).

The task can be a job scheduling task, and the final program determines how to optimally schedule jobs. That is, the task can be to optimally schedule jobs across a plurality of computational resources such that the jobs are scheduled onto the smallest number of computational resources, where each job can have a respective resource requirement, and each computational resource can have a respective total amount of resources. The computational resources can be, for example, virtual machines that are each allocated a respective total amount of resources.

As another example, the task can be designing a circuit, e.g., designing a component of an application-specific integrated circuit (ASIC), and the final computer program can determine the optimal design for this circuit. That is, the task can be to design an ASIC such that it minimizes power consumption, circuit space, and latency of operation. For example, the final computer program can be written in hardware description language (used to model electronic systems) for a key arithmetic circuit within a matrix multiplication unit of a hardware accelerator, e.g., a tensor processing unit (TPU) or other special-purpose hardware accelerator, such that the final computer program results in a design that reduces both area and power consumption of the ASIC while preserving its core functionality when applied. The inputs to the final computer program for the task can include existing functional RTL specification or hardware source code for the component and the outputs can include a new synthesized circuit design. The set of evaluation functions could include measures of physical circuit area, power consumption and latency reductions.

As another example, the task can be designing a matrix-multiplication kernel, and the final computer program (kernel) can determine the optimal matrix-multiplication kernel. That is, the task can be to design a matrix-multiplication kernel to perform matrix multiplication in hardware for arbitrarily shaped matrix inputs such that the number of operations and data movement using, e.g., the tiling strategy for matrix multiplication operations, is minimized. A kernel is a specialized computer program for execution on hardware accelerators, for example.

As another example, the task can be to generate compiled code that optimizes a machine learning model (or other software) for execution in a particular hardware environment, and the final computer program can determine the optimal compiled code for high-performance execution across different hardware platforms including GPUs, CPUs, and machine learning accelerators.

As another example, the task can be to optimize a digital signal processing (DSP) block, such as a Fast Fourier Transform (FFT) or Finite Impulse Response (FIR) filter, and the final computer program can determine the optimal hardware architecture for signal throughput . That is, the task can be to design the DSP block such that it maximizes clock frequency and minimizes the number of required multipliers and adders . For example, the final computer program can be written in Verilog to define a pipelined architecture for a high-bandwidth wireless communication chip, where the program identifies and removes redundant logic paths to reduce total switching power while maintaining signal fidelity .

As another example, the task can be designing an on-chip memory controller or a cache coherency engine, and the final computer program can determine the optimal design for data retrieval latency . That is, the task can be to design a memory management unit (MMU) that minimizes "stranded" or unutilized on-chip memory while reducing the physical area occupied by the interconnect fabric . For instance, the final computer program can provide an evolved hardware description for a multi-level cache hierarchy that employs a novel pre-fetching logic, thereby reducing the processor workload for fundamental memory-bound tasks .

As another example, the task can be to design a Power Management Integrated Circuit (PMIC) for mobile devices or autonomous sensors . The final computer program can be an HDL representation of a hardware-level power gating controller that dynamically shuts down inactive circuit islands. The task requires minimizing the total energy leakage during idle cycles while ensuring the hardware can wake up with sub-nanosecond latency, thereby directly extending the battery life of the client device.

As another example, the task can be designing specialized hardware for neuromorphic computing or spiking neural networks. The final computer program can determine the optimal sparse connectivity pattern for an array of artificial neurons to be synthesized into an ASIC . The task requires optimizing the physical design to minimize the energy-per-synaptic-operation, allowing the resulting hardware logic to perform real-time pattern recognition on the client device within a strict power budget.

As a particular example, the task can require scheduling jobs, i.e., computational workloads, across a plurality of computational resources. Generally, each job has a respective resource requirement, and each computational resource has a respective total amount of resources, e.g., memory, compute, accelerator resources, and so on, and the task requires scheduling each job on a resource that has sufficient available resources to perform the job.

Optionally, the job scheduling task can also require optimizing one or more other criteria. As a particular example, the task can require minimizing a waste metric, where the waste metric is based at least in part on a total amount of time that each computational resource is idle during a specified time window.

As a particular example, the system 100 can perform this scheduling task in an online or streaming manner. That is, each time a job is received, the system 100 is required to schedule the job given the current available resources for each of the computational resources. In this example, the waste metric is based at least in part on a total amount of time that each computational resource is idle during a specified time window during which streaming tasks are received.

Each of the evaluation functions in a set of one or more evaluation functions 108 for the task is a function that generates an evaluation score for a candidate computer program. That is, the evaluation function processes the output of a candidate computer program 135 that in turn processes a task specific input to generate an output and generates an initial evaluation score that is a metric for the quality of the output that the candidate computer program generated.

For example, to apply an evaluation function of the set of one or more evaluation functions 108 to a candidate computer program, the system can execute the candidate computer program on each of a plurality of inputs for a task to generate respective outputs for each of the inputs. The system can then generate an initial evaluation score for each output of the candidate computer program using the evaluation function and combine the initial evaluation scores for the outputs to generate the evaluation score for the candidate program.

Generally, the set of one or more evaluation functions 108 is such that each evaluation function measures different performance dimensions, complementary performance dimensions, or both. Generally, a performance dimension refers to any quality or characteristic of the candidate computer program to be measured or assessed. The performance dimension can be any appropriate performance metric.

For example, for the task of matrix-multiplication, the performance dimensions can include FLOPS (number of floating point operations) to perform the task, walltime (the total time of performing the task), peak memory usage (e.g., peak RAM usage), numerical precision (e.g., average L2-norm error between matrix multiplication output and expected matrix multiplication output), and so on.

In some cases, an evaluation function can generate an evaluation score that is a graded language model neural network feedback of the candidate computer program. That is, a language model neural network can be prompted to carry out an evaluation of the candidate computer program and to provide an evaluation score with respect to one or more performance dimensions. For example, a language model neural network can be prompted to generate and evaluate a candidate computer program on a scale of 0-100 on how "interpretable" the program is. As another example, when the candidate program represents a mathematical function, the language model can be prompted to generate an evaluation score between 0-1 on how likely it is that the mathematical function satisfies a required property (such as infinite differentiability) described in the specification data.

What follows are some examples of tasks and some examples of corresponding sets of evaluation functions.

Examples of tasks and corresponding sets of evaluation functions include job scheduling (i.e., scheduling computational jobs onto a set of computational resources). The inputs to the final computer program for the task can include a stream of job requests, each including a multidimensional resource requirement (e.g., CPU, TPU, memory, etc.), and the output can include a specific assignment of each job to a computation resource that minimizes idle time. The set of evaluation functions 108 could include a measure of the amount of free computational resources, and a count of job throughput per unit of walltime.

As another example, the task can be logic optimization (i.e., determining a new equivalent logic circuit for a received logic circuit, where the new logic circuit adheres to one or more constraints and maintains the same functionality) for digital electronics and integrated circuit design. The inputs to the final computer program for the task can include an existing digital logic circuit design and the output can be a new, equivalent logic circuit that maintains the same functionality but adheres to stricter power or area constraints as the existing digital logic circuit. The set of evaluation functions 108 could include measures of the logic circuit size, the logic circuit execution latency, the logic circuit power consumption, etc.

As another example, the task can be controlling embedded systems with strict timing constraints, such as those found in automotive, aerospace, or industrial automation applications. The inputs to the final computer program for the task can include real-time sensor data or system states, and the output can include control signals for hardware components in the embedded system. The set of evaluation functions 108 could include measures of timing performance, resource usage, and stability.

As another example, the task can be communicating network packets over a network for specific communication scenarios. The inputs to the final computer program for the task can include raw data packets and network topology information and the output can include a routed data stream for communicating the network packets. The set of evaluation functions 108 could include measures of bandwidth, latency, error rates, packet loss, and other network performance metrics.

As another example, the task can be code compilation (i.e., generating optimized code transformations of received high-level code to machine executable code). The inputs to the final computer program for the task can include high-level source code and the output can include optimized code transformations to achieve machine executable code. The set of evaluation functions 108 could include measures of code execution speed, code size, and code execution energy consumption.

As another example, the task can be hardware design synthesis (i.e., designing digital circuits by synthesizing hardware description language [HDL] code that meets specific performance and area requirements). The inputs to the final computer program for the task can include functional specification or source code, and the output can include a synthesized circuit design. The set of evaluation functions 108 could include assessments of circuit area, circuit power consumption, and circuit timing characteristics.

As another example, the task can be database querying (i.e., querying a database using efficient query plans for database systems to minimize query execution time of a query). The inputs to the final computer program for the task can include one or more database queries and the output can include efficient query execution plans. The set of evaluation functions 108 could include measures of query latency and resource utilization.

As another example, the task can be image and signal processing (e.g., image processing tasks such as noise reduction, object recognition, or image compression). The inputs to the final computer program for the task can include raw image or signal data and the output can include processed images or identified objects. The set of evaluation functions 108 could include assessments of image quality, processing speed, and compression ratio.

As another example, the task can be scientific computing and simulation, such as those used in computational fluid dynamics or weather forecasting. The inputs to the final computer program for the task can include initial physical conditions or data related to the particular scientific simulation and the output can include the results of the scientific computing and simulation. The set of evaluation functions 108 could include measures of simulation accuracy and computational cost.

As another example, the task can be cybersecurity threat detection (i.e., detecting and mitigating cybersecurity threats by analyzing network traffic and system logs). The inputs to the final computer program for the task can include real-time network logs and traffic data and the output can include threat alerts or mitigation actions to mitigate threats. The set of evaluation functions 108 could include assessments of the accuracy and speed of threat detection.

As another example, the task can be fault diagnosis and repair (i.e., diagnosing and repairing complex systems, such as aircraft engines or industrial machinery). The inputs to the final computer program for the task can include system diagnostic logs and the output can include repair procedures and/or identified fault locations. The set of evaluation functions 108 could include measures of the effectiveness and efficiency of diagnostics and repairs.

As another example, the task can be bioinformatics tasks (i.e., analyzing biological data, such as DNA sequences or protein structures). The inputs to the final computer program for the task can include raw genomic or proteomic data and the output can include identified sequences or protein structures. The set of evaluation functions 108 could include assessments of the accuracy and efficiency of the analysis.

As another example, the task can be lossless data compression (i.e., compressing data without any loss of information, targeting specific data types or characteristics). The inputs to the final computer program for the task can include raw data files and the output can include compressed bitstreams of data. The set of evaluation functions 108 could include assessments of the compression ratio and processing speed.

As another example, the task can be error-correcting (i.e., error-correcting code in data transmission and in storage with noisy environments). The inputs to the final computer program for the task can include corrupted data signals and the output can include corrected data outputs. The set of evaluation functions 108 could include measures of the error correction capability and code redundancy.

As another example, the task can be encrypting communication and data. The inputs to the final computer program for the task can include plain text data and the output can be secure encrypted data (e.g., ciphertexts). The set of evaluation functions 108 could include assessments of the security strength and computational efficiency of the encryption.

As another example, the task can be formal verification (i.e., generating formal proofs to verify the correctness and safety of hardware and software systems). The inputs to the final computer program for the task can include system specifications and/or properties and the outputs can include formal mathematical proofs of correctness. The set of evaluation functions 108 could determine the completeness and soundness of the generated proofs.

As another example, the task can be automated test case generation (i.e., synthesizing test cases for software and hardware systems to ensure comprehensive testing and identify potential bugs). The inputs to the final computer program for the task can include software or hardware source code and the outputs can include comprehensive test suites for testing the software and/or hardware systems. The set of evaluation functions 108 could include measures of code coverage and fault detection capability.

As another example, the task can be performance modeling and prediction (i.e., predicting the performance of software and hardware systems under different workloads and configurations). The inputs to the final computer program for the task can include system configurations and workload parameters, and the outputs can include performance predictions. The set of evaluation functions 108 could include assessments of the accuracy of the performance predictions.

As another example, the task can be resource allocation and scheduling in cloud computing (i.e., efficiently allocating and scheduling resources in cloud computing environments). The inputs to the final computer program for the task can include virtual machine requests and hardware status and the outputs can include resource allocation maps for allocating and scheduling the cloud computing resources in response to the request. The set of evaluation functions 108 could include measures of resource utilization and task completion time.

As another example, the task can be power management of mobile devices (i.e., generating power management plans for mobile devices to maximize battery life). The inputs to the final computer program for the task can include device usage patterns and battery levels and the output can include dynamic power management plans. The set of evaluation functions 108 could include measures of energy consumption and device performance.

As another example, the task can be directing traffic flow in smart cities (i.e., directing traffic flow in urban environments using real-time data from sensors and connected vehicles).The inputs to the final computer program for the task can include real-time data from connected vehicles and sensors and the outputs can include traffic signals and/or routing directions. The set of evaluation functions 108 could include measures of traffic congestion and travel time.

As another example, the task can be prompt engineering natural language prompts for a specific language model task (i.e., prompt engineering received prompts for a task like text summarization, translation, or question answering). The inputs for the final computer program for the task can include raw natural language prompts and the output can include optimized prompt templates for the specific language model task. The set of evaluation functions 108 could include measures of the quality of the language model’s output based on metrics like ROUGE score (Recall Oriented Understudy for Gisting Evaluation score), BLEU score (Bilingual Evaluation Understudy score), and accuracy.

As another example, the task can be decoding using language models (i.e., decoding encoded data using a language model). The inputs to the final computer program for the task can include encoded data sequences and the output can include the decoded data (e.g., decoded text). The set of evaluation functions 108 could consider metrics like text perplexity, decoding speed, and memory usage.

As another example, the task can be data augmentation for language model training (i.e., augmenting training data to improve the robustness and generalization of a trained language model that uses the augmented training data during training). The inputs to the final computer program for the task can include existing training datasets and the output can include the augmented training data samples. The set of evaluation functions 108 could include measures of the language model’s performance on downstream tasks after training with the augmented data.

As another example, the task can be fine-tuning of a language model (i.e., fine-tuning language models to adapt to specific domains or user preferences). The input to the final computer program for the task can include domain-specific datasets and user preferences and the output can include fine-tuned parameters of the language model. The set of evaluation functions 108 could include measures of the language performance on domain-specific datasets or user satisfaction.

As another example, the task can be language inference of a language model on specific hardware (i.e., language model inference on specific hardware platforms, such as GPUs or specialized hardware accelerators). The inputs to the final computer program for the task can include pre-trained language models and hardware specifications and the output can include the generated output of the language model. The set of evaluation functions 108 could include measures of inference speed and energy consumption.

As another example, the task can be optimizing hyperparameters for image generation models (i.e., determining optimal hyperparameter settings for training or fine-tuning image generation models, improving image quality and training stability). The inputs to the final computer program for the task can include image datasets and model architectures for the image generation models and the output can include one or more optimal hyperparameter settings. The set of evaluation functions 108 could include metrics like FID (Fréchet Inception Distance) or Inception Score.

As another example, the task can be synthesizing novel loss functions for image generation (i.e., generating new loss functions that better capture perceptual similarity or other desirable properties of generated images). The inputs to the final computer program for the task can include target perceptual properties to be captured and the output can include new mathematical loss functions. The set of evaluation functions 108 could include assessments of the quality and diversity of the generated images.

As another example, the task can be generating data augmentation for image generation model training (i.e., augmenting data for training image generation models to improve their robustness and generalization). The inputs to the final computer program for the task can include one or more baseline image datasets and the output can include synthetic, augmented image data (e.g., augmented images). The set of evaluation functions 108 could include measures of the quality and diversity of generated images on unseen datasets.

As another example, the task can be sampling for image generation (i.e., image generation during inference). The inputs to the final computer program for the task can include noise vectors and/or latent representations and the outputs can include final generated images. The set of evaluation functions 108 could include metrics like image quality and sampling time.

As another example, the task can be image generation model inference on specific hardware. The inputs to the final computer program for the task can include one or more image models and specific hardware profiles and the outputs can include the final generated images. The set of evaluation functions 108 could include measures of inference speed and energy consumption.

As another example, the task can be electric grid optimization (i.e., determining an optimal power flow to generate electricity in a manner that meets consumer demands while respecting the physical and operational limits of the electric grid). The inputs to the final computer program for the task can include consumer demands and operational limits of the electric grid and the outputs can include generated optimal power flow solutions. The set of evaluation functions could include measures of the accuracy of the generated solution, the physical feasibility of the solution (such as nodal power balance), and the computational speed of the solver.

As another example, the task can be mathematical construction discovery (i.e., generating heuristic search algorithms to discover mathematical constructions with optimal combinatorial, analytic, or geometric properties, such as Erdős’s minimum overlap problem). The inputs to the final computer program for the task can include mathematical definitions and constraints and the outputs can include specific heuristic search algorithms or mathematical constructions. The set of evaluation functions could include assessments of specific mathematical constraints, such as the number of non-overlapping unit hyperspheres tangent to a central unit hypersphere (for the kissing number problem), or the minimum distance ratios for packing polygons efficiently.

As another example, the task can be multidimensional job scheduling (i.e., vector bin-packing of CPU and memory requirements to efficiently allocate workloads within large-scale computational infrastructure). The inputs to the final computer program for the task can include CPU and memory requirements (e.g., requirement vectors) and the output can include efficient workload allocation plans (e.g.., a workload schedule). The set of evaluation functions could include metrics measuring the reduction of "stranded" or unutilized compute and memory resources.

As another example, the task can be optimizing compiler-generated code for specific neural network architectures (i.e., directly optimizing the compiled code for a FlashAttention kernel encapsulating both GPU kernel execution and input/output processing). The inputs to the final computer program for the task can include compiled code snippets and the outputs can include optimized kernel configurations. The set of evaluation functions could include measures of kernel execution speedup and pre- and post-processing latency reductions. The described examples of tasks and their corresponding evaluation functions above are just a few of any of a variety of tasks and corresponding evaluation functions.

With these examples of tasks and their corresponding evaluation functions, attention is directed back to the initial description of the system.

The candidate generation operations can include selection of the one or more candidate computer programs 135. In particular, the system 100 can select one or more selected candidate computer programs 135 from the program database 120 to be evolved using the respective sets of one or more evaluation scores for the candidate computer programs in the database 120. The program database 120 can correspond to a database configured to store a population of candidate computer programs and a respective set of one or more evaluation scores associated with each computer program in the population of candidate computer programs. Each of the evaluation scores can measure a respective performance dimension of the candidate computer program on the task. Examples of performance dimensions can include execution latency, memory consumption, numerical accuracy, gate count/area, power consumption, or timing slack. The candidate computer programs with which the program database 120 is initialized can be any appropriate candidate computer programs. For example, the system can initialize the program database 120 with any candidate computer programs that are received as input as example programs for performing the task.

In some implementations, the system 100 selects a parent, or root program, and one or more auxiliary programs. In such an example, the parent program can serve as the primary code template being modified and the one or more auxiliary programs can provide additional code examples and logic to guide the generation process of the new candidate computer programs 175 and provide the language model neural network 160 additional context for generation.

The system 100 can perform this selection using any appropriate method.

In some implementations, the system 100 can perform one or more sampling methods, such as, for example, inverse frequency weighting, softmax temperature sampling, etc.

In some implementations, the system 100 performs this selection so that candidate computer programs 135 with respective sets of evaluations scores that include higher evaluation scores (indicating better performance on the task across multiple performance dimensions) are more likely to be selected (“favored”).

In some cases, to select candidate computer programs 135 with better performance on the task across multiple performance dimensions, the system 100, for each candidate computer program in the program database 120, determines whether the respective set of one or more evaluation scores for the candidate computer program satisfies one or more criteria. Then, the system 100 selects the candidate computer program 135 in response to determining that the respective set of one or more evaluation scores for the candidate computer program 135 satisfies one or more criteria.

In some implementations, to determine whether the respective set of one or more evaluation scores for the candidate computer program satisfies one or more criteria, the system 100 determines an aggregate score using the respective set one or more evaluation scores and then determines that the aggregate score satisfies the one or more criteria.

For example, the system 100 can determine an aggregate score that is the mean of the evaluation scores included in the set of evaluation scores and then determine that the average evaluation score exceeds a threshold value.

Also, as part of the respective candidate generation operations, the system 100 can generate, using a prompt generator 140, an input prompt 155 for the one or more language model neural networks 160 based on the selected candidate computer programs 135. That is, the input prompt 155 includes the code from the one or more selected candidate computer programs 135.

The prompt generator 140 can be any appropriate engine configured to assemble input prompts 155. In some implementations, the input prompt 155 can include the source code of the selected candidate computer programs 135.

In some implementations, the prompt generator 140 can include a language model neural network.

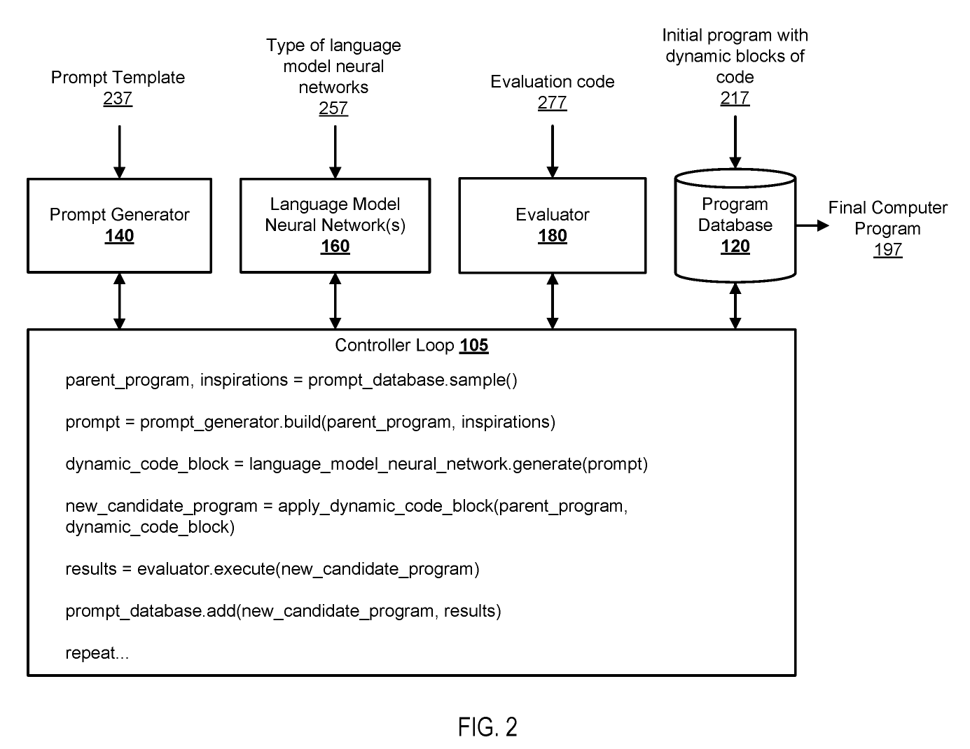

Generally, in addition to the code from the selected candidate computer programs 135, the input prompt 155 can include information that guides the generation of new candidate computer programs 175. For example, the input prompt 155 can include instructions on how to propose changes to candidate computer programs 135, e.g., “improve the dynamic blocks of code captured by API indicating block-start and block-end point for each of the dynamic blocks of code”. In some implementations, the information that guides the generation of new candidate programs 175 can be received from a user of the system 100 through a prompt template (e.g., the prompt template 237 of FIG. 2). That is, the user can provide a prompt template during initialization of the system 100, described in more detail below with reference to FIG. 2, where the prompt template includes these instructions.

In some cases, the input prompt 155 includes one or more optional additional inputs, such as one or more of explicit context of the task, one or more instructions to maintain consistency between changes to one or more components of the candidate program, prompt templates with stochastic placeholder arguments, rendered evaluation results, and rules for applying a gradual evaluation cascade (described below). As such, the input prompt 115 can provide rich context and feedback to the one or more language model neural networks 160.

Explicit context of the task can include one or more of natural language text

instructions, equations, code, or relevant literature that describes or is otherwise relevant to the task. In some cases, the system 100 generates the explicit context of the task using a language model neural network (e.g., the system processes a prompt to generate the context using a language model neural network). For example, explicit context could be a description of the task from a suitable source, e.g., the explicit context can be a description of the task from an online webpage such as an online encyclopedia.

Some prompt templates with stochastic placeholder arguments include template placeholders with provided alternatives, instantiated using probability distributions. Examples of stochastic placeholder arguments can include directives to “suggest a crazy idea” or to “focus on simplification.” For example, stochastic formatting can mean that in specific percentages of generated prompts different respective high-level instructions to generate candidates are used. That is, the prompt generator 140 can sample high-level instructions from a set of possible instructions when generation each input prompt of the one or more input prompts 155.

Rendered evaluation results include, for each selected candidate computer program in the input prompt, the respective set of evaluation scores associated with the candidate computer program. The evaluation results can also include execution traces or other artifacts in response to executing the candidate computer program.

In some cases, the prompt generator 140 can generate the one or more input prompts 155 for the one or more language model neural networks 160 using meta prompting. That is, the prompt generator 140 can generate an initial input prompt and use a language model neural network to improve the initial input prompt to generate the one or more input prompts 155.

In some cases, the input prompt 155 for a first language model neural network is different from the input prompts for each other language model neural network of the one or more language model neural networks 160.

For example, the selections of candidate computer programs 135 for each prompt can occur independently of each other and therefore the respective input prompts 155 that include the selected candidate computer program 135 are different.

As another example, the prompt generator 140 can determine the optional additional inputs associated with each input prompt independently. For example, the stochastic placeholder arguments can be different for different prompts due to its inherent stochastic nature.

That is, the prompt generator 140 can generate a different prompt for each of the language model neural networks 160.

Also, as part of the respective operations, the system 100 can process, for each language model neural network of the one or more language model neural networks 160, the input prompt 155 for the language model neural network using the language model neural network to generate one or more new candidate computer programs 175. In particular, this generation can involve producing code modifications that the system 100 can apply to the candidate computer program 135 to generate a new candidate computer program 175. In particular, each language model neural network of the one or more language model neural networks 160 can identify the one or more code segments within a selected candidate computer program 135 for modification based on the task context and evaluation scores included in the input prompt 155 and generate improved code for patching into the selected candidate computer program 135. For example, the language model neural network 160 can generate a new code segment for the candidate computer program 135 that provides an improved or alternative implementation for the segment of code within the candidate computer program 135 marked for modification. The system 100 can then synthesize a new candidate computer program 175 by automatically locating the matching code segment within the source file of the selected candidate computer program 135 and applying the patch provided by the replacement code. This targeted modification process allows the system 100 to efficiently scale the evolution of large codebases by avoiding the requirement for the language model neural network 160 to rewrite entire files for each iteration. The one or more language model neural networks 160 can be any appropriate language model neural networks.

In some cases, the one or more language model neural networks 160 differ from one another. For example, the language model neural networks 160 can differ from one another in terms of architectures (e.g., the models have different sized architectures, e.g., can have different number of parameters, neural network layers, neurons per layer, attention blocks, attention heads per layer, and so on). The use of different architectures allows the system 100 to generate new programs with different amounts of computational latency, effectively utilizing varied hardware accelerators like TPUs or GPUs.

For example, each of the language model neural networks 160 may employ various different architectures or techniques, such as transformers, attention-based mechanisms, variational auto-encoders, recurrent neural networks, convolutional neural networks, or generative adversarial networks, which are all effective for capturing complex intra prompt dependencies.

A language model neural network can be one that auto-regressively generates output response sequences by processing a prompt context sequence. The input and output sequences can be, e.g., sequences of text tokens, e.g., words, word pieces, bytes, characters, numbers, punctuation, or other text symbols.

Generally, each of the language models of the language model neural networks 160 is a pre-trained language model neural network. That is, the system 100 or another system trains the language model neural network on any of a variety of data or tasks prior to the use of the language model for generating a final computer program 197 and the neural network is not trained, i.e., is held “fixed,” while the system 100 performs the set of search operations.

For example, the system 100 or another system can train each language model neural network of the one or more language model neural networks 160 on one or more of a next prediction token objective, a masked token prediction objective, an instruction tuning objective, a supervised fine-tuning objective, and so on. Then, after training, the system 100 can use the language model neural network to perform the set of search operations.

As a particular example, a language model neural network can be Codey, a language model built on top of the PaLM2 model family as described in ArXiv:2305.10403, which has been fine-tuned on a large corpus of code.

As another particular example, a language model neural network can be Gemini as described in ArXiv:2312.11805, a language model designed to handle natural language tasks that include code chat, and code generation.

As another particular example, a language model neural network can be Gemma as described in ArXiv: 2403.08295, a model built from the same research and technology used to create Google's Gemini models.

As another particular example, a language model neural network can be CodeGemma, a model designed specifically for code generation and code completion that is built from the same research and technology used to create Google's Gemini models.

As another particular example, the one or more language model neural networks can include language model neural networks that utilize a common architecture but have different parameters values, e.g., in response to being pretrained, finetuned, or both, differently from one another.

When compared to training the trainable weights of a language models starting from randomly initialized values for each task, using pretrained language model neural networks to search through the space of candidate computer programs 135 to determine the final computer programs 197 for different tasks has the advantage of saving time (by avoiding the need to train a language models for each task), compute resources (by avoiding the compute cost of training a language model for each task), and infrastructure costs (by avoiding the memory cost of storing multiple language models). Additionally, using pretrained language model neural networks offers control over outputs through the choice of different model sizes. For example, a larger language model, such as PaLM 2-L, can be chosen for tasks that require sophisticated contextual understanding, while a smaller model, like PaLM 2-S, can be chosen for tasks where computational efficiency and diversity of outputs are priorities.

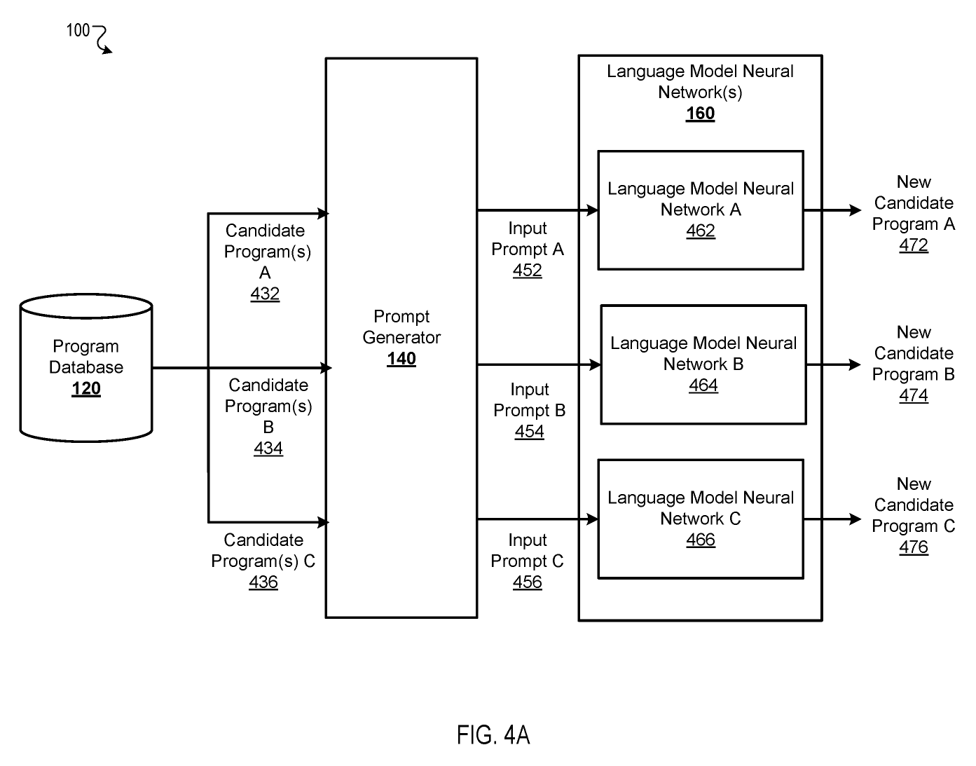

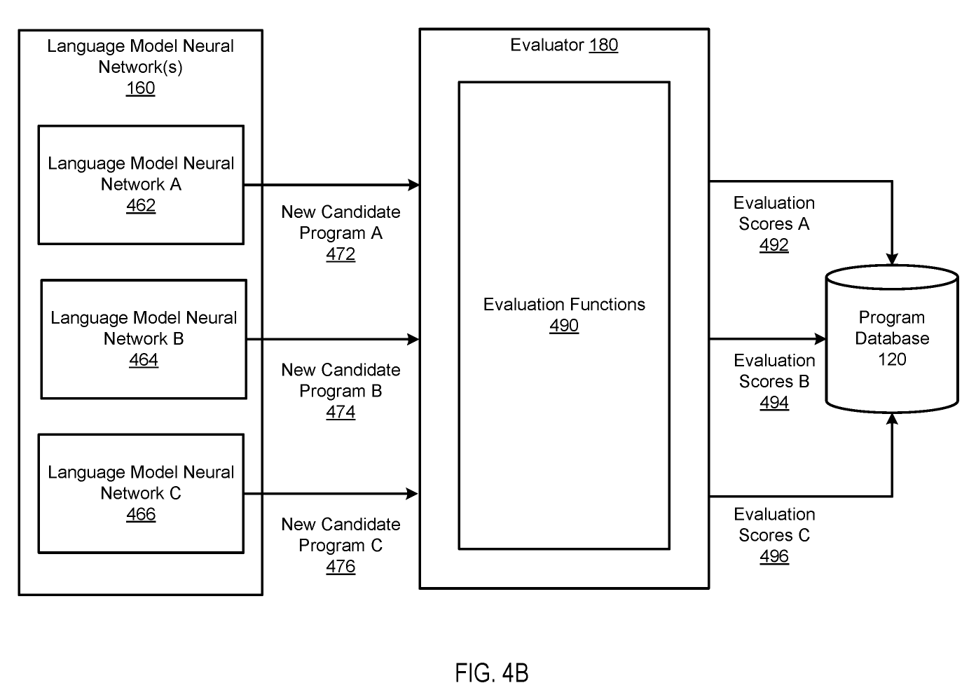

Additionally, as part of the search, the system 100 can repeatedly perform evaluation operations using the evaluator 180. The evaluator 180 can receive the new candidate computer programs 175 and determine their sets of evaluation scores. The evaluator 180 can execute each new program on a set of task-specific inputs to generate outputs, which are then processed by the set of evaluation functions 108. Thus, in some implementations, the evaluator 180 executes the new program and carries out the task in doing so. In some implementations, the evaluator 180 can correspond to one or more evaluator devices as described in more detail below with reference to FIG. 4A and 4B. In some implementations, the evaluator 180 can include one or more hardware simulators, or FPGA prototypes to execute and verify the output of a new computer program. For example, when the new candidate computer program include Verilog code, the evaluator 180 can execute and verify the output on a hardware simulator or FPGA simulator.

As one of the evaluation operations, the system 100 can identify, using the evaluator 180, one or more new candidate computer programs 175 that are not associated with evaluation scores. That is, as described in more detail below with reference to FIG. 4A and 4B, the system 100 utilizes a decoupled architecture where candidate generation and evaluation are performed as independent asynchronous processes. For example, one or more sampler devices can continuously generate and register new candidate computer programs 175 in the program database 120 in parallel without waiting for previously generated programs to be scored. Correspondingly, the evaluator 180 can independently poll the program database 120 to identify one or more new candidate computer programs 175 that are not yet associated with evaluation scores and need to be evaluated.

After identifying the new candidate computer programs 175, as another one of the evaluation operations, the system 100 can apply, using the evaluator 180, the set of one or more evaluation functions 108 for the task to each of the identified new candidate computer programs 175 to determine a set of one or more evaluation scores for the new candidate computer program 175 that each measures a respective performance dimension of the new candidate computer program 175 on the task.

In some cases, the evaluator 180 can apply the set of one or more evaluation functions 108 as a gradual evaluation cascade where the evaluator 180 applies the one or more evaluation functions 108 sequentially according to a predefined order such that, after applying the first evaluation function, the evaluator 180 applies the succeeding evaluation function only if the preceding evaluation score satisfies a respective evaluation score criterion. This prunes unpromising candidates early and conserves computational resources.

Also, as another one of the evaluation operations, the system 100 can add the new candidate computer program 175 to the program database 120 of candidate computer programs.

In some cases, to add the new candidate computer program 175 to the database 120, the evaluator 180 can determine whether the new candidate computer program 175 satisfies one or more criteria and only adds the new candidate computer program 175 to the program database 120 in response to candidate satisfying the one or more criteria. Some example criteria include: the new candidate computer program 175 having less than a maximum execution, the new candidate computer program 175 consuming less than a maximum amount of memory during execution, and the new candidate computer program 175 not producing invalid outputs that do not satisfy the specification data.

Also, as another one of the evaluation operations, the system 100 associates the new candidate computer program 175 that satisfies the one or more criteria with the set of one or more evaluation scores for the new candidate computer program 175 in the database.

In some cases, the system 100 can end performing the search operations when one or more criteria are satisfied. Examples of criteria include reaching a convergence threshold (i.e., the sets of evaluation scores of the newest candidate programs no longer improves relative to previously new candidate computer programs), reaching a pre-defined set of evaluation scores (i.e., the set of evaluation scores of the newest candidate programs exceed pre-defined values), or reaching a maximum number of search iterations (i.e., the system performs the search operations a pre-defined number of times).

After performing the search to update the program database 120, the system 100 can select one of the candidate computer programs from the database as a final computer program 197 for performing the task using the respective sets of one or more evaluation scores for the candidate computer programs in the program database 120.

For example, the system 100 can select the final computer program 197 with the highest evaluation score for a specific performance dimension that is included in the sets of one or more evaluation scores.

As another example, the system 100 can select the final computer program 197 with the highest aggregation score determined using the sets of one or more evaluation scores for each program.

As another example, the system 100 can sample the final computer program 197 from a subset of the candidates that satisfy one or more criteria regarding the evaluation scores in the respective set of evaluation scores.

After selecting the final computer program 197, the system 100 can use the final computer program 197 to perform the task on new inputs, i.e., by performing the operations represented by the final computer program 197.

As described above, the final computer program 197 can be a script in one or more programming languages or one or more HDL languages, specification for hardware physical synthesis or a complied binary for specialized hardware accelerators (e.g., TPU, GPU, etc.).

For example, the system 100 can execute the final computer program 197 on a given set of one or more hardware devices or the system 100 can map the operations specified by the final computer program 197 to a heuristic or rule to be applied to new inputs for the task and then apply the heuristic or rule on new inputs for the task.

As another example, the system 100 can provide the final computer program 197 to one or more hardware synthesis tools for arrangement of physical logic gates and interconnections. That is, the final computer program 197 can be an optimized circuit design or optimized architecture of a hardware component, and the system 100 can use the final computer program 197 to synthesize a hardware design.

In other implementations, the system 100 can cause the final computer program 197 to be deployed on an external system or device. The system 100 can transmit the final computer program 197 to the external system or device. The external system or device can execute the final computer program 197 to carry out the task. For example, where the task relates to job scheduling in a data center, the system 100 can transmit the final computer program 197 to a control node of the data center to deploy the final computer program 197 to carry out job scheduling. In another example, where the final computer program 197 is specifically adapted for execution on a particular type of hardware device, e.g. a TPU, the system 100 can transmit the final computer program 197 to a device of that type. In a further example, where the task relates to the design of an object, the system 100 can cause the manufacture of an object according to the final computer program 197.

Generally, the system 100 can, using the controller loop 105, determine a final computer program 197 for performing any task that has inputs that can be represented as inputs to a computer program (e.g., the skeleton computer program of the specification data 110) and outputs that can be represented as outputs of a computer program.

FIG. 2 is a more detailed view of a sequential logic flow for a single iteration of the controller loop 105 of the system 100 described in FIG. 1.

Initially, in some implementations, a user can provide a set of configuration inputs to prepare the system 100 for performing candidate generation operations as described above with reference to FIG. 1. These inputs can include an initial program 217, a prompt template 237, a type of language model neural networks 257, and evaluation code 277. As described above, the initial program 217 may be a skeleton computer program from the specification data 110 of FIG. 1 including fixed blocks of code and one or more placeholders for dynamic blocks of code, which is received and stored in the program database 120. The prompt template 237 can provide the underlying linguistic structure and system instructions utilized by the prompt generator 140 to frame the task for the language model neural networks 160. The selection of the type of language model neural networks 257 can allow the user of the system 100 to specify an ensemble of existing or custom types of language model neural networks 160 for the candidate generation operations. For example, the user may select a mixture of more lightweight models for high-throughput generation and more heavyweight models for complex reasoning. The system 100 can use the evaluation code 277 to initialize the evaluator 180 with task-specific evaluation functions 108 received by the system 100 required to verify candidate performance.

Once initialized, the system 100 can execute the controller loop 105 by executing code representing the candidate generation operations and evaluation operations described in FIG. 1.

To begin, the system 100 can execute a candidate generation operation that samples the one or more selected candidate programs. In particular, the system 100 can retrieve a candidate program (or parent program) and a set of auxiliary programs from the program database 120. As described above with reference to FIG. 1, in some implementations, the system 100 can sample a candidate program and one or more auxiliary programs to assist in the evolution of the dynamic blocks of code of the candidate program.

The system 100 can then execute a build operation that generates an input prompt by the prompt generator 140. The prompt generator 140 can assemble a rich in context input prompt including the source code of the sampled programs, and in some cases, rendered evaluation results, stochastic instructions, etc.

The system 100 can execute a candidate generation operation that executes a language model neural network 160. The language model neural network 160 can process the input prompt to generate a code modification for a dynamic code block of the parent program. As described above, the language model neural network 160 can generate a code modification for a dynamic code block of the parent program using the one or more sampled auxiliary programs.

The system 100 can apply the generated dynamic block of code to the parent program to synthesize the new candidate program. In some cases, this synthesis can involve patching the specific dynamic blocks of code identified by the placeholders in the parent program.

The system 100 can execute an evaluation operation of the controller loop 105 by the evaluator 180 to generate results and evaluation scores. In particular, the evaluator 180 can execute the new candidate program, including one or more evaluation functions that have been added to the new candidate program. The resulting output of the new candidate program can include the one or more evaluation scores associated with the new candidate program.

The system 100 can execute another evaluation operation by adding the new candidate program and its associated results back into the program database 120, making it available for selection in subsequent iterations of the controller loop 105.

The system 100 can then repeat the candidate generation operations of the controller loop 105 until a final computer program 197 is determined.

FIG. 3 is a diagram illustrating a detailed view of specification data 110, which includes an initial computer program, also referred to as a skeleton computer program 312. The specification data 110 can serve as the primary input to the system 100, providing the high-level logic framework and environmental constraints necessary for the evolutionary discovery process. The skeleton computer program 312 can define the task to be performed and can include a mix of immutable logic and mutable regions designated for optimization.

In particular, the skeleton computer program 312 can include one or more dynamic blocks of code 314A and 314B and one or more fixed blocks of code 316. The dynamic blocks of code 314A and 314B represent the target areas within the codebase for mutation, refinement, and improvement during the code generation operations performed by the system 100. For example, a dynamic block 314A can include specific package imports. As an example, a dynamic block 314B can include core logic functions, such as a calculate_packing_score function or search heuristics.

As the initial implementation of these dynamic blocks 314 within the specification data 110 must be complete to ensure the program is executable, the dynamic blocks 314 can be filled with placeholder code that is then replaced during evolution of the skeleton computer program 312. For example, the dynamic blocks 314A and 314B are associated with respective placeholders 315A and 315B. In some implementations, these placeholders 315A and 315B can include markers that identify these specific code segments to the system 100 as being available for evolution. For example, each of the placeholders 315A and 315B can include an input API that indicates a block-start point and a block-end point for the respective dynamic block of code. For example, the system can recognize specific comment markers, such as # EVOLVE-BLOCK-START and # EVOLVE-BLOCK-END, to delineate the boundaries of a dynamic block 314. In such an example, this API-driven approach allows the system 100 to target and evolve multiple components across a codebase simultaneously, even if those components are located in different sections of the file or across different functions or classes. For example, in the electric grid optimization example described above, the system 100 can target and evolve the network architecture, the training objective and the optimization algorithm simultaneously, maintaining context across each of the modifications, ensuring changs in one component is consistent with change in another. In some implementations, the placeholder code can include a single-line function that merely returns a constant value or a basic identity. As such, the system 100 can modify specific pieces of code (e.g., dynamic blocks of code 314) across large files without losing the context of the rest of the system within the candidate program.

The skeleton computer program 312 can further include a fixed block of code 316. The fixed block 316 represents the immutable sections of the codebase that remain constant during the search to update the program database 120. These sections can include boilerplate architecture, data loading procedures, or the evaluation logic itself, such as the set of evaluation functions 108 of FIG. 1. By maintaining these sections as fixed, the system 100 ensures that the environment in which the candidate programs are tested remains consistent, providing a stable baseline for measuring performance improvements.

In some implementations, the skeleton computer program 312 can further include docstrings, one or more relevant primitive functions, and/or one or more import packages (e.g., if not part of a dynamic block of code).

Generally, the architecture of the skeleton computer program 312 is language-agnostic. While some implementations may utilize Python, the skeleton computer program 312 can be implemented in any programming language, including C++ or Verilog for hardware description. In such cases, the placeholders are adapted to the specific commenting or annotation syntax of the target language. This flexibility allows the system 100 to optimize programs ranging from high-level scientific heuristics to low-level hardware circuits.

As a specific example depicted in FIG. 3, the skeleton computer program 312 can represent code for the kissing numbers problem. The kissing number problem is a classic puzzle in geometry and sphere packing that answers the question “how many non-overlapping unit spheres can simultaneously touch (or “kiss”) a central unit sphere of the same size?” A fixed block of code 316 for the kissing numbers problem can include constant values (e.g., dimensionality and mathematical constants), verification logic (e.g., verify_configuration as seen in FIG. 3) that ensures no two spheres overlap, any data structures, etc. A dynamic block 314B, identified by a placeholder 315B, can include logic functions (e.g., a calculate packing score function for calculating how many spheres can be “packed” into a central unit sphere as depicted in FIG. 3), evaluation functions, etc. By replacing the placeholder 315B with evolved code, the system 100 can iteratively refine the machine learning model's performance on a given dataset.

At a high level, the fixed blocks of code 316 can provide the underlying structure and environment of the code, ensuring the new candidate program maintains the more essential components. The placeholders 315 are the blanks within the code that the system 100 fills with increasingly effective or efficient dynamic blocks of code to make the computer program perform the task more efficiently (e.g., in terms of computation or memory), or generate a higher quality output.

FIGS. 4A and 4B are diagrams illustrating a parallelized candidate generation and evaluation process using the one or more language model neural networks 160.

In some cases, the system 100 can parallelize performing the search operations described in FIG. 1 and 2 across a plurality of devices, e.g., computer hardware devices. Examples of such devices include CPUs, and devices that include one or more hardware accelerators, e.g., TPUs or GPUs or both. That is, the system 100 can parallelize the operations such that, at any given time, two or more devices are performing the same subset of the search operations in parallel (but in association with different candidate programs). The two or more devices can be homogenous (i.e., all devices are of the same type of computer hardware devices) or heterogeneous (i.e., two or more of the devices are of different types of computer hardware).

For example, the system 100 can include one or more programs database devices, one or more sampler devices, and one or more evaluator devices, where the one or more sampler devices and the one or more evaluator devices operate in parallel with each other and communicate asynchronously to perform the candidate computer program search. The programs database 120 can store and serve candidate computer programs 135, the samplers can generate new candidate computer programs using one or more language model neural networks 160, while the evaluators 180 assess new candidate computer programs using the set of evaluation functions (e.g., the evaluation functions 108 of FIG. 1).

In some cases, the system 100 performs the respective candidate generation operations for each of the one or more language model neural networks 160 asynchronously from and in parallel with the respective operations for each other language model neural network of the one or more language model neural networks 160. For example, multiple language model neural networks can each operate on separate processing threads (software, hardware, or both) across one or more devices to operate independently of each other (i.e., in parallel and asynchronously to each other).

In some implementations, the system 100 performs the evaluation operations asynchronously from and in parallel with the respective candidate generation operations for each of the one or more language model neural networks 160. For example, evaluation devices can perform evaluation operations on new candidate computer programs generated from a language model neural network while the language model neural network simultaneously is generating additional new candidate computer programs. That is, in some implementations, the controller loop (e.g., the controller loop 105 of FIG. 1) can be implemented as an asynchronous pipeline, for example, using the Python asyncio library. This architecture allows the plurality of sampler devices and the plurality of evaluator devices to operate concurrently and independently. Asynchronous parallelism enables the system 100 to maximize throughput, allowing the language model neural networks 160 to propose new ideas while the evaluator 180 simultaneously processes previously generated programs. Such an implementation supports the scaling of the search process across heterogeneous hardware accelerators, such as TPUs and GPUs, utilizing specialized programming frameworks like JAX or Pallas for kernel-level optimizations.

In some cases, when the system 100 includes one or more sampler devices, each sampler device maintains a respective instance of (some or all of) the one or more language model neural networks 160, and each sampler device repeatedly performs, for each of the one or more language model neural networks 160, iterations of the selecting, generating, and processing in parallel with each other language model neural network.

For example, as illustrated in FIG. 4A and 4B, the system 100 can execute three iterations of selecting, generating and processing with three language model neural networks in parallel: a language model neural network A 462, a language model neural network B 464, and a language model neural network C 466.

Following the candidate generation and evaluation process described and illustrated in FIGS. 1 and 2, the system 100 can select one or more candidate programs from the program database 120. For example, the system 100 can select a first set of candidate programs A 432 for the language model neural network A 462, a second set of candidate programs B 434 for the language model neural network B 464, and a third set of candidate programs C 436 for the language model neural network C 466 concurrently. Each of the sets can include different "root”, or parent programs paired with various "inspiration" auxiliary programs to ensure diverse exploration of the search space.

In some implementations, to select the one or more candidate programs, the system 100 can submit a query to the one or more programs database devices, and obtain, in response to the query and from the one or more programs database devices, the one or more selected computer programs. For example, the system 100 can submit a query to a first program database device and receive, in response to the query, the one or more candidate programs A 432 while in parallel, submitting a query to a second program database device, and receive, in response to the query, the one or more candidate programs B 434.

The prompt generator 140 can receive each of the sets of candidate programs 432, 434, and 436 to generate a corresponding unique input prompt based on the candidate programs. For example, the prompt generator 140 can produce an input prompt A 452, an input prompt B 454, and an input prompt C 456 in parallel.

Each of the language model neural networks 462, 464 and 466 of the language model neural networks 460 can process the corresponding input prompt to generate the new candidate program. For example, a language model neural network A 462 can process input prompt A 452, while a language model neural network B 464 and a language model neural network C 466 process input prompts B 454 and C 456, respectively. As described above, these instances can reside on separate sampler devices or hardware accelerators. The processing results in one or new candidate programs including a new candidate program A 472, a new candidate program B 474, and a new candidate program C 476.

Generally, the computational latency associated with processing each input prompt by the language model neural networks is independent of each other. That is, different language model neural networks take different amounts of computational latency (time) to generate new candidate computer programs because (i) the language model neural networks can be different from each other (e.g., have different architectures), (ii) the prompts can be different from each other (e.g., different sampled programs are included in the prompt), and (iii) the system can use multiple (potentially heterogeneous devices) to asynchronously and in parallel perform candidate generation operations across sampler devices.

Continuing the process as illustrated in FIG. 4B, the evaluator 180 can receive the new candidate programs 472, 474, and 476 and apply a set of one or more evaluation functions 490 in parallel. In some implementations, the evaluator 180 comprises an evaluation cluster that handles asynchronous calls to execute and score the programs. This process generates independent sets of results for each of the new candidate programs 472, 474, and 476, shown as evaluation scores A 492, evaluation scores B 494, and evaluation scores C 496. Each set of scores measures respective performance dimensions, such as numerical precision or execution latency, for its corresponding candidate program. Once the scores are determined, the new candidate programs 472, 474, and 476 and their associated result sets are registered asynchronously back into the program database 120.

Because the pipeline is asynchronous, the iteration B corresponding to the language model neural network 464 does not need to wait for iteration A corresponding to the language model neural network 462 to complete its generation, evaluation or registration before beginning its own generation or evaluation cycle. This is particularly advantageous when the system 100 handles different language model neural networks with different computational latencies. For example, a high-throughput, low-latency model instance may complete the generation of new candidate program A 472 while a high-capability, higher-latency model is still processing the complex reasoning required for input prompt C 456.

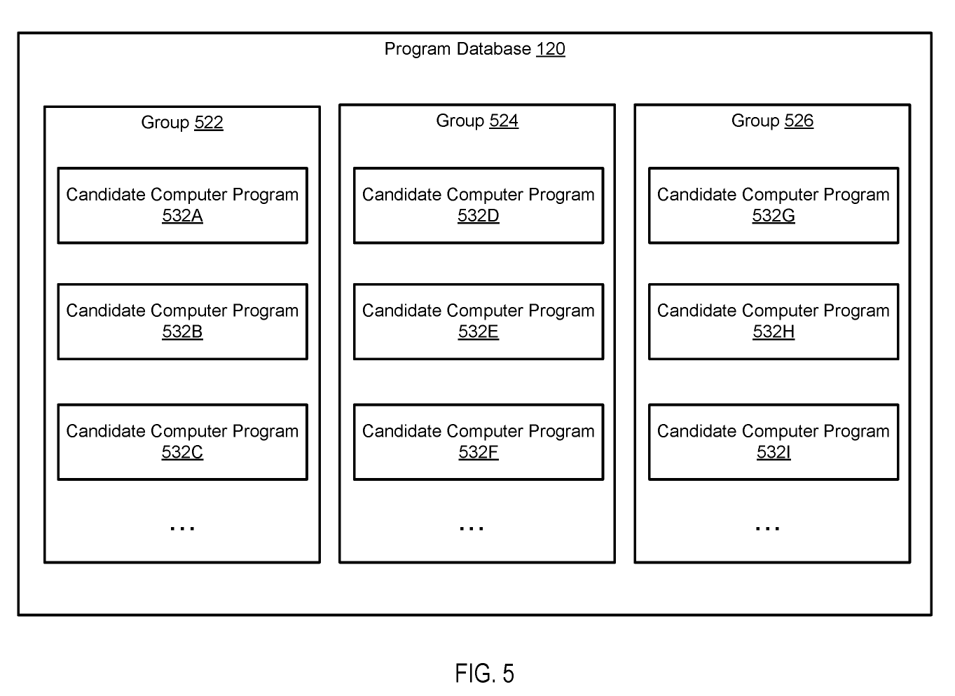

FIG. 5 illustrates more detail of a program database 120, which can be partitioned into one or more groups to facilitate an evolutionary search for candidate computer programs. As described above with reference to FIG. 1, the program database 120 can be implemented as a distributed storage system or a hybrid database architecture that manages a population of candidate computer programs and their associated metadata (e.g., the respective set of one or more evaluations scores).

In some implementations, the one or more candidate computer programs of the program database 120 can be partitioned into one or more groups, such as a first group 522, a second group 524, and a third group 526 as depicted in FIG. 5. In some implementations, these groups can represent isolated populations or distinct storage archives based on performance and diversity. For example, one or more groups of candidate computer programs, referred to as the elite groups, serve as a global archive of the best-performing programs discovered for each optimization metric. As an example, one or more other groups, referred to as the island groups, can maintain isolated populations of evolved programs to preserve diversity and mitigate premature convergence. Within these groups, the program database 120 can store one or more candidate computer programs, such as candidate computer programs 532A-I. For example, the program database 120 can store candidate computer program 532A-C in group 522, candidate computer programs 532D-F in group 524, and candidate computer programs 532G-I in group 526. Each candidate computer program is associated with a respective set of one or more evaluation scores that measure respective performance dimensions of the candidate program on a task, such as numerical precision, execution latency, or memory consumption.

When selecting one or more candidate computer programs for candidate generation as described above with reference to FIG. 1 and 4A and 4B, the system 100 can perform sampling operations to retrieve programs.

In some implementations, the system 100 utilizes a hybrid selection strategy. For example, the system 100 can sample from one of the elite groups with a first probability to favor exploitation of high-fitness candidate computer programs, while sampling from one of the island groups with a second probability to encourage exploration of diverse candidates. In some implementations, the first probability and the second probability can be 0.5, such that there is an equal chance that the system 100 samples from one of the elite groups or one of the island groups. Within each selected group, the system 100 can utilize stochastic techniques to select specific candidate computer programs. For example, for the one or more islands groups, the system 100 can employ softmax temperature scaling (e.g., using a temperature T=0.1) to sample programs (e.g., a parent program and one or more auxiliary programs) based on their normalized evaluation scores. As an example, for the one or more elite groups, the system 100 can utilize inverse frequency weighting to ensure uniform coverage when sampling (e.g., the parent program and one or more auxiliary programs), thereby preventing the search from converging on a small set of dominant programs and favoring a diversity of optimal trade-offs.

As described above with reference to FIG. 1 and 2, in some implementations, the system 100 can sample a parent program and one or more auxiliary programs. In some implementations, when sampling, the system 100 can retrieve a "root" or parent program and one or more auxiliary programs from the same selected group (e.g., one of the islands of the one or more island groups) to maintain contextual consistency during the subsequent prompt generation phase. In such an example, the system 100 can sample from the same group, e.g., group 522, group 524, and group 526. For example, when sampling from one of the elite groups, the system 100 can sample both the parent program and the one or more auxiliary programs from the same elite group.

In some implementations, the program database 120 can further implement dynamic database management and resampling to maintain population health. That is, the program database 120 can modify or reset the one or more groups (e.g., the groups 522, 524, and 526). For example, the system 100 can monitor specific criteria to determine when to modify or reset the groups. For example, the system 100 can determine that criteria are satisfied for modifying groups based on fixed time intervals (e.g., every 4 hours) or a detection of performance stagnation. In response, the system 100 can identify one or more groups based on their evaluation scores, discard the candidate computer programs from the identified groups, and perform a reseeded reset. During this process, top-performing programs can be sampled from groups that were not identified for reset and added to the identified groups to reseed new islands. This ensures that promising algorithmic traits are redistributed across the population while flushing out unpromising lineages.

In some implementations, the candidate computer programs within each group are further organized into a set of clusters. The system 100 can cluster programs based on initial evaluation scores for one or more task-specific inputs, the sets of aggregate evaluation scores, or both. When sampling a program from a selected group, the system 100 can first sample a cluster and then sample the program from the sampled cluster. This hierarchical sampling can use techniques that favor clusters containing high-performing programs or techniques that favor shorter candidate computer programs within a cluster to reduce computational overhead and improve code interpretability.

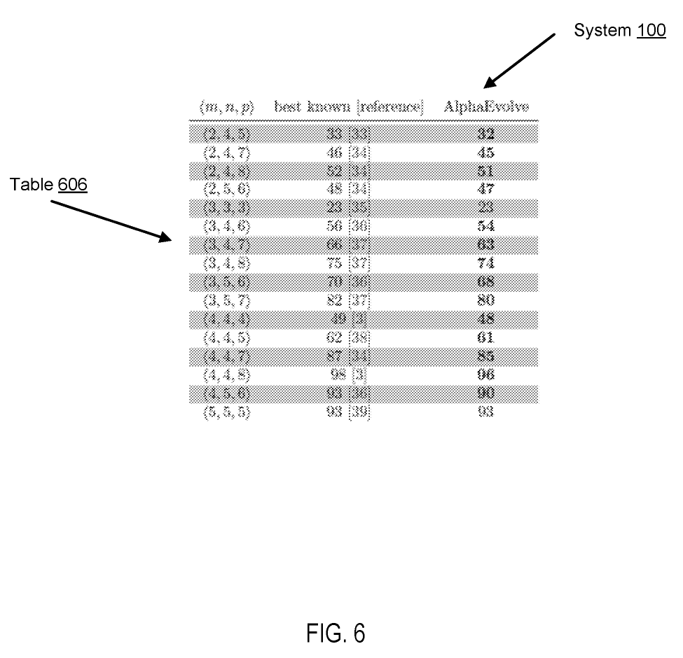

FIG. 6 is a table 606 comparing performance metrics for a matrix multiplication task between a baseline of best-known solutions and a computer program generated by the system 100. The table 606 provides empirical evidence of the system 100's ability to discover computational procedures that either match or surpass the efficiency of algorithms developed through decades of human expert research and specialized mathematical methods.

For example, the system 100 can receive a task to optimize a matrix-multiplication kernel. As a specific example, the specification data 110 can define the task of multiplying two 4x4 matrices, where the initial candidate program in the program database 120 might include a standard gradient-based optimization loop using a basic Adam optimizer and a simple L2 reconstruction loss. The system 100, or in particular, the prompt generator, can assemble a prompt containing this code and its current evaluation scores. A language model neural network can process the prompt and suggests a new dynamic block of code that replaces the Adam optimizer with an AdamW variant and adds a custom "discretization loss" to encourage entries to be multiples of 0.5. The evaluator 180 executes this new candidate computer program 175 across multiple random seeds, determining that it achieves a lower rank (e.g., 48 multiplications instead of 49). Because this program satisfies the quality criteria, it is registered in the database 120 and eventually selected as the final computer program 197.

The table 606 includes multiple columns representing the technical parameters and results of the above example discovery process. A first column, labeled (m, n, p), represents the dimensions of the matrix multiplication target, where an m x n matrix is multiplied by an n x p matrix. A second column, labeled "best known [reference]," lists the previously established upper bounds for the number of scalar multiplications required for each respective target. A third column represents the ranks achieved by the system 100. As illustrated, the system 100 matches or surpasses the best-known solutions in all depicted instances.

In a specific technical breakthrough shown in FIG. 6, for the target (4, 4, 4), the system 100 discovered an algorithm requiring 48 scalar multiplications. This represents a significant improvement upon the 49 multiplications required by Strassen's algorithm, which remained the undisputed record-holder for approximately 56 years. The engineering significance of this reduction in rank is direct: each term in the tensor decomposition corresponds exactly to one scalar multiplication, reducing the rank from 49 to 48 directly reduces the computational complexity and arithmetic operations required to compute the matrix product.

The results depicted in FIG. 6 provide explicit support for the capability of the system 100 to design an optimal matrix-multiplication kernel. In some implementations, the final computer program 197 serves as a specialized heuristic that outperforms existing human-designed experts by introducing original algorithmic ideas. As detailed in the code modifications suggested during the search, these ideas can include specific weighting schedules, parameter clipping, and gradient noise injection.

Alternative implementations of the system 100 can be configured to evolve programs for different mathematical objectives. For example, in addition to standard bilinear complexity or tensor rank, the system 100 can be utilized to evolve programs for "support rank," which is a metric specifically related to boolean matrix multiplication. This flexibility allows the system 100 to be applied across a broad spectrum of algorithmic discovery tasks where computational efficiency is a primary performance dimension.

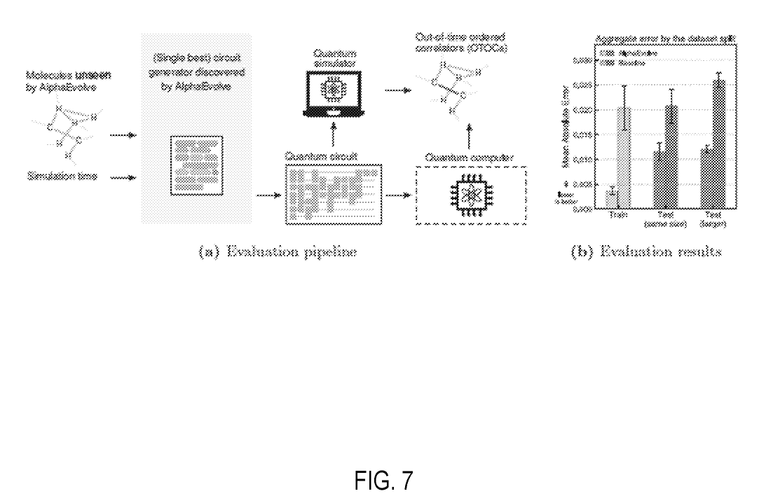

FIG. 7 illustrates an evaluation pipeline and resulting bar chart illustrating error results for a quantum circuit generator task. The above described system 100 can be utilized to discover a final computer program 197 that functions as a circuit generator configured to produce high-fidelity quantum circuits for approximating the continuous-time evolution of complex quantum systems.

As illustrated in the evaluation pipeline of FIG. 7, the system 100 can receive inputs including molecular data and a specified simulation time. The molecular data can include structural and interaction information for molecules previously "unseen" by the system 100, such as data retrieved from a Protein Data Bank (PDB). A final computer program 197, which represents a circuit generator discovered through the search operations of the system 100, processes these inputs in a feed-forward manner. For example, this circuit generator functions as an evolved heuristic that takes the molecular data and simulation time to instantly construct a unique quantum circuit tailored to the specific molecule. In some implementations, the generated circuit is processed through a quantum simulator or actual quantum hardware to calculate out-of-time ordered correlators (OTOCs). These OTOCs serve as a building block for capturing the structural information of the molecule, where the approximation error is minimized relative to high-fidelity simulation benchmarks.

The empirical performance data associated with this process is illustrated in the bar chart of FIG. 7 The performance is assessed across three distinct data partitions: a "train" set used during the search to update the program database 120, a "test (same size)" set including molecules of a similar size range as the training set (e.g., up to 10 atoms), and a "test (larger)" set comprising larger molecular systems (e.g., 11 to 16 atoms). The Y-axis represents the mean absolute error (MAE) in OTOC approximation. As depicted, the solution generated by the system 100 achieves a significantly lower error—approximately a 2x reduction—compared to a first-order Trotter baseline across all three partitions.

The system 100 successfully disentangles general circuit construction logic from the specifics of the training data, as evidenced by the high generalization and extrapolation performance on the "test (larger)" molecules. This capability allows the system 100 to produce valid circuits for larger systems where direct classical verification becomes computationally intractable. During the evaluation operations, the evaluator 180 can perform multi-objective optimization to balance resource efficiency, such as gate count, with approximation error (e.g., as supported by Claims 1 and 52). Once the final computer program 197 is selected, it can be applied to new inputs in a zero-shot manner without additional re-optimization. This demonstrates the "instrumental goal" of the system 100: evolving an algorithm that can produce a solution rather than merely searching for a specific solution directly.

The molecular use case in FIG. 7 provides explicit support for performing a task by executing operations represented by the final computer program (and the utilization of multi-dimensional evaluation scores. In a concrete quantum chemistry example, the system 100 evolves a circuit generator that captures fundamental principles of quantum simulation that remain invariant across varied molecular structures. This allows the system 100 to surpass the state-of-the-art Trotter decomposition, which typically requires significant circuit depth to achieve high fidelity.

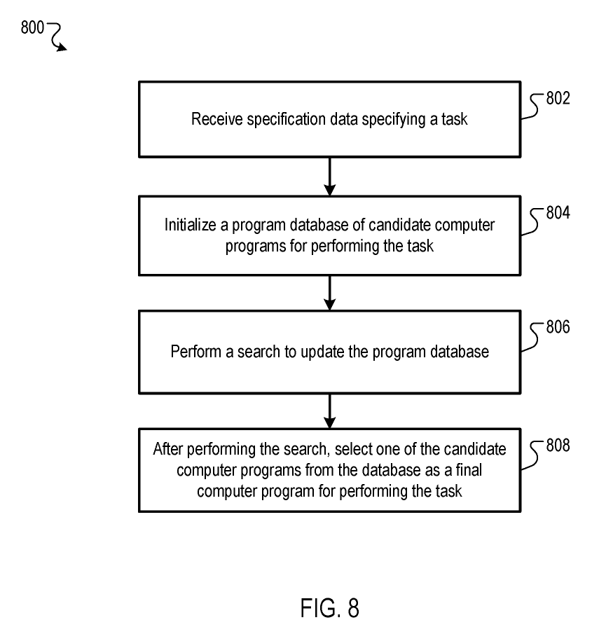

FIG. 8 is a flowchart of a process for selecting a candidate computer program as a final computer program for performing a task. For convenience, the process 800 will be described as being performed by a system of one or more computers located in one or more locations. For example, a system, e.g., the system 100 depicted in FIG. 1, appropriately programmed in accordance with this specification, can perform the process 800.

The system can receive specification data specifying a task (step 802). As described above with reference to FIG. 1, the task can be any appropriate task. For example, in some implementations, the task is an optimization task, such as job scheduling across computational resources (e.g., virtual machines), designing an optimal matrix-multiplication kernel, or designing an optimal integrated circuit. The specification data can be any appropriate specification data that specifies the task and may include a skeleton computer program with fixed blocks and placeholders for dynamic blocks. In some implementations, the skeleton computer program may include additional information such as docstrings, primitive functions, or import packages. Each placeholder may include an input API indicating block-start and block-end points.

The system initializes a program database of candidate computer programs, where each candidate is associated with a set of evaluation scores measuring performance dimensions like execution latency or memory consumption (step 804). As described above with reference to FIGS. 1 and 5, the system can initialize a program database of candidate computer programs, where the candidate computer programs can correspond to, for example, preliminary versions of computer programs written in one or more programming languages, such as C++, Python, or both, that are generated based on the skeleton computer program of the specification data.

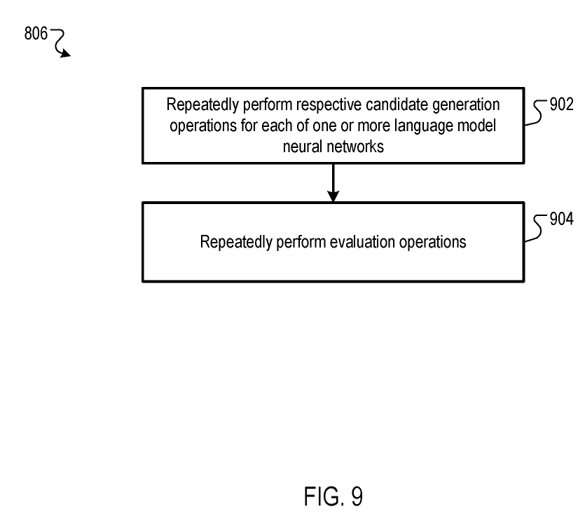

The system performs a search to update the program database (step 806). The process of step 806 is described in more detail with reference to FIGS. 9, 10 and 11.

After performing the search, the system selects one of the candidate computer programs as a final computer program for performing the task using the evaluation scores (step 808). As described above with reference to FIG. 1, the system can select a final computer program from the program database using the respective sets of one or more evaluation scores for the candidate computer programs in the program database 120. Examples of selection method include select the final computer program with the highest evaluation score for a specific performance dimension that is included in the sets of one or more evaluation score, selecting the final computer program with the highest aggregation score determined using the sets of one or more evaluation scores for each program, selecting the final computer program from a subset of the candidates that satisfy one or more criteria regarding the evaluation scores in the respective set of evaluation scores.

In some implementations, the system can perform the task by executing the operations represented by the final computer program, which may represent a heuristic for carrying out the optimization task. As described above with reference to FIG. 1, the system 100 can use the final computer program to perform the task on new inputs, e.g., by performing the operations represented by the final computer program.

FIG. 9 is a flowchart of a subprocess for performing a search to update a program database of the process of FIG. 8. In particular, FIG. 9 illustrates a subprocess of step 806 of FIG. 8 for performing a search to update a program database.

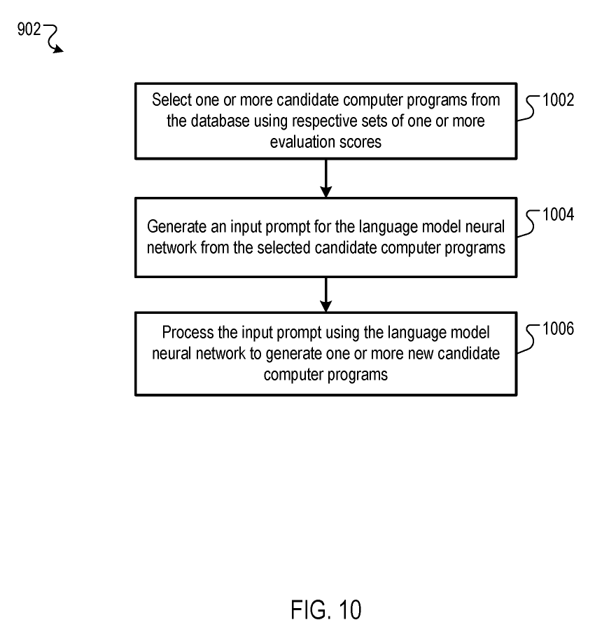

The system repeatedly performs respective candidate generation operations for each of a one or more language model neural networks (step 902). As described above with reference to FIG. 1, 2, 4A and 4B, the system can repeatedly perform respective candidate generation operations using a controller loop. The respective candidate generation operations are described in more detail with reference to FIG. 10. In some implementations, these candidate generation operations are performed asynchronously from and in parallel with the operations for each other language model neural network.

In some implementations, the one or more language models may include different architectures that generate candidates with different amounts of computational latency.

Simultaneously, the system repeatedly performs evaluation operations (step 904). As described above with reference to FIG. 1, 2, 4A and 4B, system can repeatedly perform respective evaluation operations using a controller loop. In some implementations, these evaluation operations are performed asynchronously from and in parallel with the respective candidate generation operations.

In some implementations, the system comprises multiple hardware devices, including one or more programs database devices, one or more sampler devices, and one or more evaluator devices, all of which operate in parallel and asynchronously with each other.

FIG. 10 is a flowchart of a subprocess for performing candidate generation operations using a language model neural network of the process of FIG. 9. In particular, FIG. 10 illustrates a subprocess of step 902 of FIG. 9.

The system selects one or more candidate computer programs from the database using the respective sets of one or more evaluation scores (step 1002). As described above with reference to FIG. 1, 2, 4A and 4B, the system can select one or more candidate computer programs for modification. In some implementations, the selection may involve determining if the evaluation scores satisfy specific criteria, such as an aggregate score meeting a threshold. In some implementations, the program database can be partitioned into groups. In such an example, the system selects a group (e.g., via uniform sampling) and samples candidates from that group. In some implementations, candidates within a group may be clustered based on evaluation scores or task inputs, and the system may sample by first selecting a cluster and then selecting a program, potentially favoring shorter programs.

In some implementations, each sampler device of one or more sampler devices of the system can maintain an instance of the language model neural networks and repeatedly performs iterations of selecting, generating, and processing.

In some implementations, selecting the one or more candidate computer programs can include submitting a query to the database devices to obtain the selected programs.

The system generates an input prompt for the language model from the selected candidate computer programs (1004). As described above with reference to FIGS. 1, 2, 4A and 4B, the system can generate an input prompt based on the selected candidate computer programs. In some implementations, the input prompt generated for each language model neural network may be different for each and may include additional inputs like explicit context, stochastic placeholder arguments, or rendered evaluation results. For example, the explicit context may be generated using a language model neural network.

The system can process the input prompt, using the language model neural network, to generate one or more new candidate computer programs (1006). As described above with reference to FIG. 1, 2, 4A and 4B, the language model neural network can process the input prompt to generate a new candidate compute program, where the language model neural network generates a new segment of code to replace a portion of the candidate computer program marked for modification. That is, the language model neural network can generate new portions of the candidate computer program to generate the new candidate computer program, rather than generate an entire new candidate computer program.

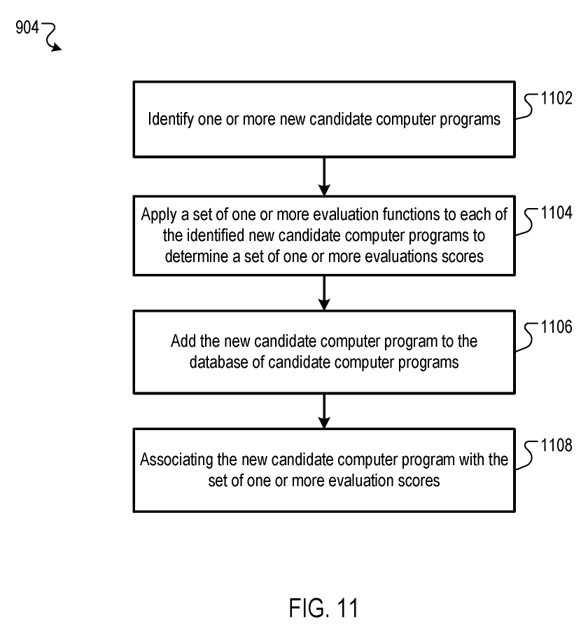

FIG. 11 is a flowchart of a subprocess for performing evaluation operations on new candidate computer programs of the process of FIG. 9. In particular, FIG. 11 is a subprocess of the step 904 of FIG. 9.

The system identifies new candidate programs not yet associated with evaluation scores (step 1102). As described above with reference to FIG. 1, 2, 4A and 4B, the system can identify new candidate computer programs for evaluation from one or more candidate compute programs generated by the one or more language model neural networks. For example, each sampler device can provide new candidate computer programs to a respective evaluator device for evaluation.

The system can, using one or more evaluator devices, apply a set of evaluation functions to determine evaluation scores (step 1104). As described above with reference to FIG. 1, 2, 4A and 4B, the system can evaluate the new candidate computer programs by applying a set of one or more evaluation scores. In some implementations, applying the set of evaluation functions may include executing the program on one or more inputs, applying evaluation functions to generate initial scores, and combining them. The evaluation scores can be any appropriate scores resulting from set of one or more evaluation functions. In some implementations, the evaluation scores may include graded language model neural network feedback. In some implementations, the system can apply the evaluation functions as a gradual evaluation cascade, where succeeding functions are applied only if preceding scores satisfy a criterion.

The system adds the new candidate computer program to the database, potentially adding it to a specifically selected group (step 1106). In some implementations, the candidate computer program may only be added if it satisfies criteria such as maximum execution time, maximum memory usage, or validity of outputs.

The system can associate the candidate with its evaluation scores in the database (step 1108). As described above with reference to FIG. 1 and 2, the system can associate each candidate compute program with the respective set of evaluation scores. As such, in the next iteration of the candidate generation operations, the system can sample the candidate computer program for further modification based on the respective set of evaluation scores.

Additionally, the system may modify or discard groups in the database if modification criteria are satisfied, and reseed them with top-performing programs from other groups.

In this specification, the term "configured" is used in relation to computing systems and environments, as well as computer program components. A computing system or environment is considered "configured" to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are "configured" to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term "computing device or hardware" refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term "engine" broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small, embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard, touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by a computer system comprising one or more computers, the method comprising:
receiving specification data specifying a task;
initializing a program database of candidate computer programs for performing the task, wherein each candidate computer program in the database is associated with a respective set of one or more evaluation scores that each measures a respective performance dimension of the candidate computer program on the task;
performing a search to update the program database, wherein performing the search comprises:
repeatedly performing respective candidate generation operations for each of a plurality of language model neural networks, the respective operations for each language model neural network comprising:
selecting a plurality of candidate computer programs from the database using the respective sets of one or more evaluation scores for the candidate computer programs in the database;
generating an input prompt for the language model neural network from the selected candidate computer programs; and
processing the input prompt using the language model neural network to generate one or more new candidate computer programs; and
repeatedly performing evaluation operations comprising:
identifying, using a set of one or more evaluator devices, one or more new candidate computer programs that are not associated with evaluation scores;
applying, using the set of one or more evaluator devices, a set of one or more evaluation functions for the task to each of the identified new candidate computer programs to determine a set of one or more evaluation scores for the new candidate computer program that each measures a respective performance dimension of the new candidate computer program on the task;
adding the new candidate computer program to the database of candidate computer programs; and
associating the new candidate computer program with the set of one or more evaluation scores for the new candidate computer program in the database; and
after performing the search, selecting one of the candidate computer programs from the database as a final computer program for performing the task using the respective sets of one or more evaluation scores for the candidate computer programs in the database.

2. The method of claim 1, wherein the respective candidate generation operations for each of the plurality of language model neural networks are performed asynchronously from and in parallel with the respective operations for each other language model neural network of the plurality of language model neural networks.

3. The method of claim 1, wherein the plurality of language model neural networks comprises a plurality of language model neural networks of different architectures.

4. The method of claim 3, wherein each of the plurality of language model neural networks of different architectures generates new candidate computer programs with different amounts of computational latency than each other.

5. The method of claim 1, wherein the evaluation operations are performed asynchronously from and in parallel with the respective candidate generation operations for each of the plurality of language model neural networks.

6. The method of claim 1, wherein applying, using the set of one or more evaluator devices, the set of one or more evaluation functions for the task to each of the identified new candidate computer programs to determine the set of one or more evaluation scores for the new candidate computer program that each measures a respective performance dimension of the new candidate computer program on the task comprises:
executing the new candidate computer program on each of a plurality of inputs for the task to generate a respective output for each of the inputs;
for each input and for each evaluation function of the one or more evaluation functions, applying the evaluation function based on the execution of the new candidate computer program on the input to generate a respective initial evaluation score for the input; and
combining the initial evaluation scores for the inputs to generate the evaluation score.

7. The method of claim 1, wherein the computer system comprises:
one or more programs database devices that maintain the program database;
a plurality of sampler devices that operate in parallel with each other; and
a plurality of evaluator devices that operate in parallel with each other;
wherein the plurality of sampler devices and the plurality of evaluator devices operate in parallel with each other.

8. The method of claim 7, wherein each sampler device maintains a respective instance of the plurality of language model neural networks, and wherein each sampler device repeatedly performs, for each of the plurality of language model neural networks, iterations of the selecting, generating, and processing in parallel with each other language model neural network.

9. The method of claim 1, wherein:
the specification data comprises a skeleton computer program that specifies the task, the skeleton computer program comprising one or more fixed blocks of code and placeholders for one or more dynamic blocks of code, and wherein each new candidate computer program is a respective instance of the one or more fixed blocks of code and one or more dynamic blocks of code.

10. The method of claim 10 further comprising:
performing the task by performing the operations represented by the skeleton computer program with the final computer program in place of the placeholders for the one or more dynamic blocks of code.

11. The method of claim 1, wherein the task is an optimization task.

12. The method of claim 11, wherein the final computer program represents a heuristic for carrying out the optimization task.

13. The method of claim 12, wherein the task requires scheduling jobs across a plurality of computational resources, each job having a respective resource requirement, and each computational resource having a respective total amount of resources.

14. The method of claim 13, wherein the respective resource requirement for each job is represented across a plurality of resource dimensions, and wherein each computational resource is allocated a respective total resource amount along each resource dimension.

15. The method of claim 14, wherein the plurality of resource dimensions comprise a memory dimension and a compute dimension.

16. The method of claim 13, wherein the plurality of resource dimensions comprise one or more accelerator resource dimensions that correspond to resources provided by one or more hardware accelerators.

17. The method of claim 13, wherein the computational resources are virtual machines that are each allocated a respective total amount of resources.

18. The method of claim 11, wherein the task is to generate compiled code that optimizes a machine learning model (or software) for execution in a particular hardware environment.

19. The method of claim 1, wherein applying the set of one or more evaluation functions for the task to each of the identified new candidate computer programs to determine a set of one or more evaluation scores for the new candidate computer program that each measures a respective performance dimension of the new candidate computer program on the task comprises applying the set as a gradual evaluation cascade, wherein applying the gradual evaluation cascade comprises:
applying the one or more evaluation functions sequentially according to a predefined order such that, after applying the first evaluation function, applying the succeeding evaluation function occurs only if the preceding evaluation score satisfies a respective evaluation score criterion.

20. The method of claim 1, further comprising
providing the final computer program to a client computer system.

21. The method of claim 21 further comprising:
receiving, by the client computing system, the final computer program; and
performing, by the client computing system, the task using the final computer program.

22. The method of claim 21, wherein performing, by the client computer system and using the final computer program, the task comprises:
compiling, by the client computer system, the final computer program; and
executing, by the client computing system, the final computer program.

23. The method of claim 22, wherein the task comprises designing a matrix-multiplication kernel and the final computer program comprises an optimized matrix-multiplication kernel.

24. The method of claim 21, wherein performing, by the client computing system, the final computer program, the task comprises:
synthesizing a design of a hardware component based on an optimal architecture defined in the final computer program; and
executing hardware logic operations within the physical modified architecture..

25. The method of claim 24, wherein the task comprises designing a circuit and the final computer program defines an optimal architecture of the circuit.

26. The method of claim 25, wherein the circuit is an arithmetic circuit with a matrix multiplication unit of a hardware accelerator.

27. The method of claim 1, wherein the skeleton computer program comprises code written in a hardware description language (HDL).

28. The method of claim 1, wherein the final computer program comprises code written in a hardware description language (HDL).

29. A system comprising:
one or more computers; and
one or more storage devices storing instructions that, when executed by the one or more computers, cause the one or more computers to perform operations comprising:
receiving specification data specifying a task;
initializing a program database of candidate computer programs for performing the task, wherein each candidate computer program in the database is associated with a respective set of one or more evaluation scores that each measures a respective performance dimension of the candidate computer program on the task;
performing a search to update the program database, wherein performing the search comprises:
repeatedly performing respective candidate generation operations for each of a plurality of language model neural networks, the respective operations for each language model neural network comprising:
selecting a plurality of candidate computer programs from the database using the respective sets of one or more evaluation scores for the candidate computer programs in the database;
generating an input prompt for the language model neural network from the selected candidate computer programs; and
processing the input prompt using the language model neural network to generate one or more new candidate computer programs; and
repeatedly performing evaluation operations comprising:
identifying, using a set of one or more evaluator devices, one or more new candidate computer programs that are not associated with evaluation scores;
applying, using the set of one or more evaluator devices, a set of one or more evaluation functions for the task to each of the identified new candidate computer programs to determine a set of one or more evaluation scores for the new candidate computer program that each measures a respective performance dimension of the new candidate computer program on the task;
adding the new candidate computer program to the database of candidate computer programs; and
associating the new candidate computer program with the set of one or more evaluation scores for the new candidate computer program in the database; and
after performing the search, selecting one of the candidate computer programs from the database as a final computer program for performing the task using the respective sets of one or more evaluation scores for the candidate computer programs in the database.

30. One or more computer-readable storage media storing instructions that when executed by one or more computers cause the one or more computers to perform operations comprising:
receiving specification data specifying a task;
initializing a program database of candidate computer programs for performing the task, wherein each candidate computer program in the database is associated with a respective set of one or more evaluation scores that each measures a respective performance dimension of the candidate computer program on the task;
performing a search to update the program database, wherein performing the search comprises:
repeatedly performing respective candidate generation operations for each of a plurality of language model neural networks, the respective operations for each language model neural network comprising:
selecting a plurality of candidate computer programs from the database using the respective sets of one or more evaluation scores for the candidate computer programs in the database;
generating an input prompt for the language model neural network from the selected candidate computer programs; and
processing the input prompt using the language model neural network to generate one or more new candidate computer programs; and
repeatedly performing evaluation operations comprising:
identifying, using a set of one or more evaluator devices, one or more new candidate computer programs that are not associated with evaluation scores;
applying, using the set of one or more evaluator devices, a set of one or more evaluation functions for the task to each of the identified new candidate computer programs to determine a set of one or more evaluation scores for the new candidate computer program that each measures a respective performance dimension of the new candidate computer program on the task;
adding the new candidate computer program to the database of candidate computer programs; and
associating the new candidate computer program with the set of one or more evaluation scores for the new candidate computer program in the database; and
after performing the search, selecting one of the candidate computer programs from the database as a final computer program for performing the task using the respective sets of one or more evaluation scores for the candidate computer programs in the database.
